(19) United States
(12) Patent Application Publication
(10) Pub. No.: US 2026/0307259 A1
(43) Pub. Date: Oct. 8, 2026

(54) CONTROL DEVICE AND CONTROL METHOD OF AUTONOMOUS MOBILE ROBOT

(71) Applicants: Shibaura Machine Co., Ltd., Tokyo (JP); TOKYO METROPOLITAN PUBLIC UNIVERSITY CORPORATION, Tokyo (JP)

(72) Inventors: Yoichiro NAKAMURA, Zama (JP); Yuya WADA, Zama (JP); Naoyuki TAKESUE, Hino (JP); Masanori SEKIGUCHI, Hino (JP)

(73) Assignees: Shibaura Machine Co., Ltd., Tokyo (JP); TOKYO METROPOLITAN PUBLIC UNIVERSITY CORPORATION, Tokyo (JP)

(21) Appl. No.: 19/474,792

(22) PCT Filed: Apr. 16, 2024
(86) PCT No.: PCT/JP2024/015176

§ 371 Date: Oct. 13, 2025

(30) Foreign Application Priority Data
Apr. 25, 2023 (JP) 2023-071217

(51) Int. Cl. B25J 9/16; B25J 5/00

(52) U.S. Cl. CPC B25J 9/1682; B25J 5/007; B25J 9/1633; B25J 9/1666

(57) ABSTRACT

A control device of an autonomous mobile robot includes one or more manipulators that has a distal end to which a hand for manipulating an object is attached to move it, and a traveling mechanism that is immediately movable in all directions, includes a prioritized multi-target inverse kinematics calculation circuit that obtains a solution while assuming that there is a virtual spring between a current pose and a target pose, and each joint receives virtual torque from the virtual spring; and a priority level determination circuit that individually adjusts operation priority level coefficients that are individually assigned to actuation devices constituting the autonomous mobile robot, by which a spring coefficient of the virtual spring is multiplied, and that correspond to operation priority levels of the actuation devices.

### TECHNICAL FIELD

The present invention relates to a control device and a control method of an autonomous mobile robot including a manipulator and a traveling mechanism.

### BACKGROUND ART

In Japan, in the background of a labor shortage due to a decrease in population, a demand for work robots executing work at the same level as humans in a multipotent and autonomous manner increases in various fields. Specific examples include a robot that attaches a workpiece conveyed by a cart to a machine tool, a robot that replenishes products in a convenience store or a supermarket, a robot that dishes up various ingredients in a container in a food factory, a robot that conveys a product tray on a cart, and a robot that sorts products for each store.

It is desirable that such a robot can move by traveling or walking, has advanced work ability using both hands, and is easily introduced to the site, but there are many problems in realizing the robot. First, the problem is described in detail below.

In common to both the single arm type and the double arm type, for the traveling movable work robot including the manipulator and the hand close to the manipulator, when a certain work is executed, it is necessary to individually teach motions of each of the manipulator, the hand, and the traveling, the operations which are necessary for the work. Among these methods, the current method of teaching the manipulator is generally a method of positioning and stopping the manipulator in each pose such as the start pose and the final target pose of the operation and the intermediate pose of the operation as necessary, and then storing the pose.

Therefore, for a mobile work robot of a type in which a manipulator is mounted on a traveling mechanism that is currently in widespread use, there is no choice but to perform sequential executable control in which the manipulator is operated after traveling is stopped. As a result, the work time tends to be long, and it is difficult to teach and execute a work that requires parallel execution of an operation of moving the manipulator while moving to travel.

For example, it is difficult to perform a work of picking up a suitcase flowing on a baggage conveyor of an airport so as to trajectory the suitcase or a work of opening a door. When the latter is considered for a door of a hinged door type, the reason is that an operation of starting to open the door with the manipulator arm tip and then further moving the arm tip and continuing to move the door while moving the traveling mechanism backward is necessary. Naturally, it is very difficult for a robot in the related art to teach and execute an ordinary work for a person such as keeping the manipulator open the door while the traveling mechanism avoids the door so that the body does not collide with the opening door.

Currently, the manipulator, the hand, and the traveling are often controlled by different controllers, and further, the manipulator, the hand, the traveling mechanism, and the controllers thereof are often provided by different manufacturers. In such a case, since these actuation devices are taught by separate teaching software having separate operation methods and separate operation feelings, the work teaching in the entire robot becomes very complicated and takes a lot of time. For the same reason, it is very difficult to create a control program for executing operations of actuation devices in parallel, and the operations have to be executed sequentially, but this also extends the working time.

Since it is necessary to determine a place where the manipulator arm tip reaches the target position, stop the traveling mechanism, and teach the place to the traveling mechanism, in the case of work that requires the manipulator to guide the arm tip to a large number of different placement positions, such as product replenishment in a convenience store or a supermarket, and picking at a distribution site, it is necessary to move the entire robot and teach the traveling stop position one by one again every time the arm tip cannot reach the next placement position. This is very cumbersome and not practical. When the manipulator is moved in a wide range, there is also a risk that a portion of the manipulator collides with the body of the robot. It is more difficult to cause the robot to perform a manual work while moving and preventing this risk.

Meanwhile, when looking at the behavior of a person, in a case where the person stretches his/her hand to take an object, even if the person recognizes the positional relationship between the object and the hand, the person hardly recognizes the standing position. While extending the right hand to the object, the person unconsciously walks until the right hand is about to reach the object. However, if the foot on the left side on which the person walks is about to hit something, the person turns his/her attention to the left foot, stops walking, and moves only the right foot further forward to take an article with the right hand. When the person manipulates an object by largely moving a hand and an arm, it is not normal to hit his/her body with the hand or an elbow. This is because when the arm is in a tight pose with respect to the body, the position of the body is naturally changed with the foot while the position of the hand is maintained.

In such a behavior of a person, attention is directed to an operation that requires consideration for accuracy and safety, while an operation that does not require such consideration is unconsciously executed. It can be interpreted that one type of prioritization is naturally given to the operation according to the degree of attention.

The operation having a low priority level seems to work in an auxiliary or cooperative manner so as to satisfy the constraint that the operation having a high priority level for directing attention is established. It can be said that an information processing action in the behavior of the person limits the information processing amount necessary for the behavior with respect to the information processing resources of the brain that are not infinite.

For example, Nonpatent Literature 1 is academic research in which a robot is caused to take a behavior similar to the present idea in a different control framework using AI. The technique of Nonpatent Literature 1 uses deep learning representing AI and causes a robot to learn a behavior that requires interlocking between a manipulator and a traveling mechanism. As a work behavior example, the robot succeeds in a behavior of passing through the door.

Meanwhile, it takes several hours to teach and learn the operation, and a dedicated teaching device having the same structure and dimensions as the robot is required to teach the operation. Therefore, there are many constraints from the viewpoint of easily completing the work teaching on site in a short period of time.

Another technique for teaching a robot to perform complicated behavior through learning is a method of teaching by demonstration or a program by demonstration using Nonpatent Literature 2 as an example. This method is an approach of quantifying a locus of an operation of a hand or a foot when a person executes a certain work using a special motion sensor that measures image processing or a joint angle, converting the locus into an operation locus of a robot to be taught by some means, and causing a control device of the robot to learn the locus.

However, this method usually requires a dedicated device such as an image processing device or a motion sensor only for operation teaching, similarly to the technique of Nonpatent Literature 1. Since measurement noise occurs in image processing and motion sensing, or an operation of a person is not necessarily accurate with respect to execution of the work, it is necessary for the control device of the robot to learn an average or nearly accurate operation from a process in which the person repeats the same operation a plurality of times.

At this time, in order to appropriately transfer and convert the movement of the human body such as the arm to the operation of the robot having a size and a structure different from those of the human, the teaching method by demonstration of Nonpatent Literature 2 or the like requires an advanced learning system. There are various problems such as how to transfer and learn not only the movement of the arm but also the movement of the person walking on two legs to the wheel-running mobile robot. Solving these problems is also a theme of research and development.

What is common to these two technologies in the related art is that the control device of the robot is caused to learn the operation loci of all the actuation devices such as the manipulator and the traveling mechanism of the robot so that the control device of the robot uniformly actively and precisely reproduces the operation loci. Therefore, a large amount of teaching and learning processing is required.

### CITATION LIST

### Nonpatent Literature

Nonpatent Literature 1: H. Ito, K. Yamamoto, H. Mori, T. Ogata, Efficient multitask learning with an embodied predictive model for door opening and entry with whole-body control, Science Robotics, 6 April, Vol 7, Issue 65, 2022.
Nonpatent Literature 2: S. Calinon, A. Billard, Active Teaching in Robot Programming by Demonstration, Proceedings of 16th IEEE International Symposium on Robot & Human Interactive Communication, 2007, pp. 702-707.

### SUMMARY OF INVENTION

### Problem to be Solved by the Invention

In such a behavior of a person, attention is directed to an operation that requires consideration for accuracy and safety, while an operation that does not require such consideration is unconsciously executed. Therefore, an ordinary behavior for a person is naturally performed in a robot by a control mechanism, and it is preferable that calculation resources and an information processing amount necessary for the control can also be limited.

The present invention has been made in view of the above and provides a control method of reducing a teaching amount and a calculation amount of control while realizing a behavior like a person by a robot, and a configuration of a control device that executes the control method.

### Means for Solving Problem

In order to solve the above problem and achieve the object, a control device of an autonomous mobile robot according to the present invention is a control device of an autonomous mobile robot that includes one or more manipulators that has a distal end to which a hand for manipulating an object is attached to move it, and a traveling mechanism that is immediately movable in all directions, the control device includes: a prioritized multi-target inverse kinematics calculation means that obtains a solution while assuming that there is a virtual spring between a current pose and a target pose, and each joint receives virtual torque from the virtual spring; and a priority level determination means that individually adjusts operation priority level coefficients that are individually assigned to actuation devices constituting the autonomous mobile robot, by which a spring coefficient of the virtual spring is multiplied, and that correspond to operation priority levels of the actuation devices.

### Effect of the Invention

The control device of the autonomous mobile robot according to the present invention can reduce the teaching amount and the calculation amount of control while realizing the behavior like a person by the robot.

### BRIEF DESCRIPTION OF DRAWINGS

FIG. 1 is an external view illustrating an example of a mobile work robot according to the present embodiment;

FIG. 2 is a block diagram illustrating an example of a functional configuration of the control device of the mobile work robot according to the present embodiment and a connection relationship between functional components by inputting and outputting information;

FIG. 3 is a diagram illustrating an example of a work program stored in the control device according to the present embodiment;

FIG. 4 is a diagram illustrating an example of the work program stored in the control device according to the present embodiment;

FIG. 5 is a diagram illustrating an example of a unit operation included in the work program according to the present embodiment;

FIG. 6 is a block diagram illustrating an example of a prioritized multi-target inverse kinematics solution;

FIG. 7 is a diagram illustrating an example of a relationship between the shortest distance to the periphery of the mobile work robot and a priority level of the traveling mechanism;

FIG. 8 is a diagram illustrating an example in which an initial state of a simulation of a door opening operation is displayed in three-dimensional display;

FIG. 9 is a diagram illustrating an example in which an initial state of a simulation of a door opening operation is displayed in two-dimensional display;

FIG. 10 is a diagram illustrating an example in which a simulation result of a behavior of the mobile work robot in a door opening work is displayed in three-dimensional display;

FIG. 11 is a diagram illustrating an example in which the simulation result of the behavior of the mobile work robot in the door opening work is displayed in two-dimensional display;

FIG. 12 is a diagram illustrating an example in which the simulation result of the behavior of the mobile work robot in the door opening work is displayed in two-dimensional display;

FIG. 13 is a diagram illustrating an example in which the simulation result of the behavior of the mobile work robot in the door opening work is displayed in three-dimensional display;

FIG. 14 is a diagram illustrating an example in which the simulation result of the behavior of the mobile work robot in the door opening work is displayed in two-dimensional display;

FIG. 15 is a diagram illustrating an example of a result of performing the door opening operation by the mobile work robot according to the present embodiment;

FIG. 16 is a diagram illustrating an example of a locus of a right hand that grips and moves a door handle in the door opening operation of the mobile work robot according to the present embodiment;

FIG. 17 is a block diagram illustrating an example of information input/output between prioritized multi-target inverse kinematics calculation means and each axis angle limitation means of the present embodiment;

FIG. 18 is a flowchart illustrating an example of a flow of output determination of a joint angle target command value related to a left manipulator in the prioritized multi-target inverse kinematics calculation means of the present embodiment;

FIG. 19 is a three-dimensional graph illustrating an interference region between the left manipulator and a body in a joint space of three axes of a left manipulator on a base portion side in the mobile work robot of the present embodiment; and

FIG. 20 is a diagram illustrating an example of a memory array stored in the control device of the present embodiment.

### DESCRIPTION OF EMBODIMENTS

Specifically describing cooperative automatic interlocking between the manipulator and the traveling mechanism in an autonomous mobile robot including a manipulator and a traveling mechanism, the present invention uses a prioritized multi-target inverse kinematics solution to calculate displacement of a control shaft according to an operation priority level assigned to each of left and right manipulators and a traveling mechanism so that each of the left and right manipulators and the traveling mechanism reaches each target pose.

In addition, together with the cooperative interlocking of the manipulator and the traveling mechanism and, at the same time, movement of the traveling mechanism in a manner of assisting the manipulator so that the arm tip reaches when the manipulator tries to move to a place where the arm tip does not reach in a work that needs traveling mechanism collision avoidance, the traveling mechanism is automatically interlocked so that the execution of the operation of the manipulator is prioritized at the normal time, and the arm tip of the manipulator moves along the target trajectory. Meanwhile, when the traveling mechanism is likely to collide with the surroundings, the traveling mechanism can be operated to avoid collision by prioritizing the operation of the traveling mechanism and lowering the operation priority level of the manipulator.

As means for reducing the operation teaching amount of the manipulator, force control means based on any one of the control laws of the compliance control, the admittance control, and the impedance control is applied to the control of the manipulator. As a result of rough teaching setting, even if the arm tip pose deviates from the target trajectory of the arm tip at the time of executing the operation, an error such as overload is prevented from occurring in a drive unit.

In summary, the uniqueness of the approach of the present invention lies in the following points. That is, not all the operation trajectories of the manipulator and the traveling mechanism, which are necessary for executing the complicated work, are reproducibly taught to the control device of the robot as in other approaches of the related art and the preceding examples described above, and the manipulator and the traveling mechanism are not uniformly learned to reproduce the operation trajectories actively and precisely. The manipulator that first manipulates the object and is the subject of work execution passively and roughly learns or follows motion constraint of the manipulated object.

Further, the traveling mechanism passively learns the movement of the manipulator and also learns the surrounding environment in a manner of keeping a distance so as not to collide with the surroundings. The present invention is intended to provide the control device of the robot with the ability of both actuation devices, the manipulator and the traveling mechanism, to perform a movement constraint, a distance constraint to the surrounding environment, and to passively learn the other actuation device.

By using the property that each of the manipulator and the traveling mechanism to which the priority level of the operation is assigned eventually moves as a result of being constrained by various constraints and an operation having a higher priority level and passively learned, in other words, trajectories are arbitrarily determined, the operation is passively generated, to reduce the teaching amount and the teaching time of the operations in the entire robot.

Hereinafter, embodiments of a control device and a control method for an autonomous mobile robot according to the present disclosure are described in detail with reference to the drawings. The present invention is not limited by the embodiments. Components in the following embodiments include those that can be replaced and easily conceived by those skilled in the art or those that are substantially the same.

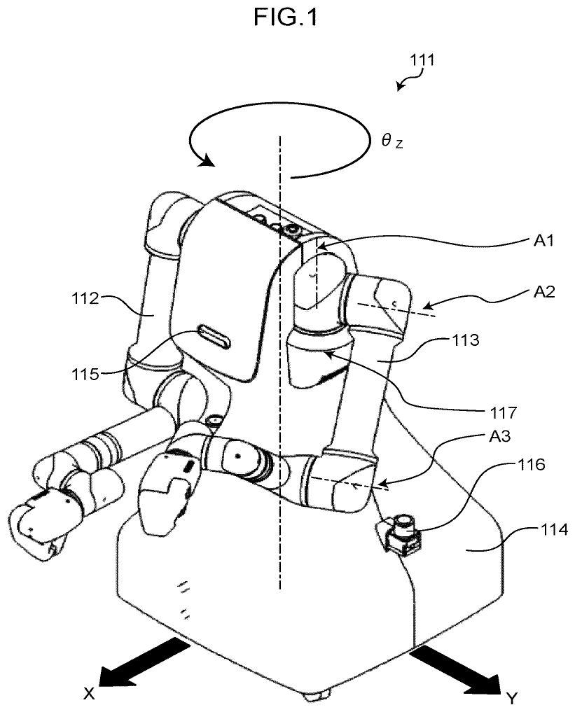

Hereinafter, a specific embodiment of the present invention is described using, as an example, a mobile work robot including an omnidirectional traveling mechanism and two right and left manipulators above the omnidirectional traveling mechanism, as illustrated in FIG. 1. The mobile work robot is an example of an autonomous mobile robot. FIG. 1 is an external view of a mobile work robot 111.

This mobile work robot 111 includes left and right manipulators (112, 113) having six joints and six degrees of freedom and an omnidirectional traveling mechanism (not illustrated) in a body 114. The omnidirectional traveling mechanism can be immediately moved in each direction of X, Y, and θ_{z} of the arrows. That is, the mobile work robot 111 includes one or more manipulators that attach a hand for manipulating an object to a distal end and move the hand, and a traveling mechanism that can immediately move in all directions.

The mobile work robot 111 includes, as external sensors, one three-dimensional camera 115 on the front side and LiDAR (Light Detection and Ranging, Laser Imaging Detection and Ranging) 116 one on each of the left and right sides on a lower side of the body 114.

The three-dimensional camera 115 can capture both an RGB two-dimensional image and a depth image in which distance depths of points on an imaging object corresponding to respective pixels of the two-dimensional image are listed. The LiDAR 116 scans the surroundings with a laser beam, measures flight time of beam reflected light, and measures a distance to the surroundings in a predetermined angular range. In specific examples of the present invention and examples showing the effects of the present invention, simulation results for the mobile work robot 111 and data of actual machine operation are described.

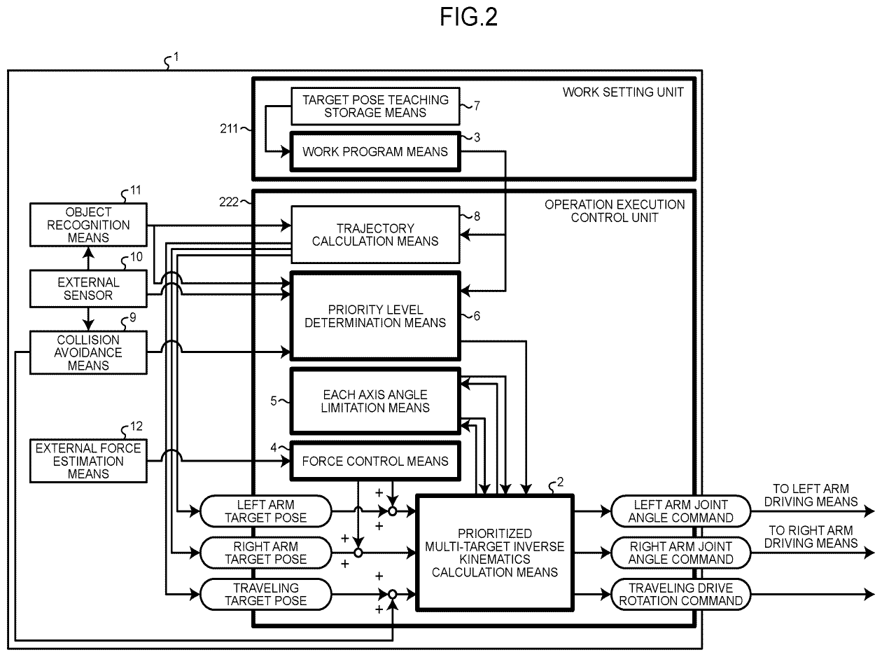

FIG. 2 is a block diagram illustrating a configuration of a control device 1 of the mobile work robot 111 illustrated in FIG. 1 and a connection relationship between components by input and output of information. The control device 1 of the mobile work robot 111 according to the present embodiment includes collision avoidance means 9, an external sensor 10, object recognition means 11, external force estimation means 12, a work setting unit 211, and an operation execution control unit 222. It is desirable that function execution means that configures the collision avoidance means 9, the object recognition means 11, the external force estimation means 12, the work setting unit 211, and the operation execution control unit 222 is executed by the same CPU due to restrictions on the size of the robot and manufacturing cost. However, the present invention is not limited thereto.

The collision avoidance means 9 avoids a collision based on a distance measurement value with respect to the periphery of the mobile work robot 111. The collision avoidance means 9 adds a corrected displacement corresponding to the avoidance amount to the target pose in each control period of the traveling mechanism. The collision avoidance means 9 may add the correction speed to the target speed in each control period of the traveling mechanism. Any technology can be applied to the collision avoidance means 9 as long as the technology is a type of outputting the correction amount of the pose or the correction amount of the speed that is the first differentiation of the pose on the premise of the omnidirectional traveling.

Examples of the external sensor 10 include various two-dimensional and three-dimensional cameras for recognizing a manipulation target or a person around the mobile work robot 111, sensors such as LiDAR, a laser range finder, and an ultrasonic sensor for measuring a distance from the periphery of the mobile work robot 111, a bumper switch for detecting a collision of the traveling mechanism unit, a contact or proximity sensor for detecting contact with or approach to a manipulator or a surrounding object attached to the body 114 of the mobile work robot 111, and a force sensor attached to the manipulator arm tip.

Although not illustrated in the block diagram of FIG. 2, the control device 1 of the mobile work robot 111 includes an interface unit that acquires a sensor output value corresponding to a signal type of each sensor. An upper limit value and a lower limit value with respect to the sensor input value are usually set in the interface unit, and an error is output when the sensor input value deviates from the upper limit value or the lower limit value. Although the connection of the error output signal is not illustrated in FIG. 2, the error output signal is output to a warning lamp or a drive unit, and the warning lamp is turned on or the power supply of the drive unit is cut off according to the type of the output signal.

Although not illustrated in FIG. 2 because it is not essential, the control device 1 of the mobile work robot 111 may also include an internal sensor such as a torque sensor that measures joint torque of the manipulator. The interface and error processing of these internal sensors are handled similarly to the external sensor 10.

Distance point group data and image data acquired by the external sensor 10 such as a three-dimensional camera or a two-dimensional camera are input to the object recognition means 11. Based on the data, the mobile work robot 111 recognizes the presence or absence of an object to be manipulated by the manipulator and the hand attached to the arm tip thereof, and the pose of the manipulation target. The object to be recognized may include not only an artificial object but also a natural object such as a person, an animal, or a crop in accordance with the purpose of use of the mobile work robot 111.

The external force estimation means 12 refers to a known external force estimation method of estimating an external force from joint torque of a manipulator without using a general force sensor or a sensor that measures an external force applied to a manipulator arm tip, a known external force estimation method based on a torque measurement value of a torque sensor attached to a joint of a manipulator, or the like. The interface and error processing of the external force estimation means 12 are handled similarly to the external sensor 10.

The work setting unit 211 includes target pose teaching storage means 7 and work program means 3. The target pose teaching storage means 7 stores a plurality of poses for each actuation device that configures the mobile work robot 111. For example, the work instructor of the mobile work robot 111 manually operates the traveling mechanism and the manipulator of the robot through a user interface such as a teaching pendant, a tablet, or a touch panel and causes the traveling mechanism and the manipulator to take the final target pose and the passing pose in the operation necessary and appropriate for work execution.

When instructed to store the poses by the work instructor, the target pose teaching storage means 7 stores the poses so that the poses are used as the final target pose and the passing pose at the time of programming in the work program means 3. The target pose teaching storage means 7 stores the plurality of poses added in this manner for each actuation device configuring the mobile work robot 111, such as the traveling mechanism, the manipulator, and the hand.

The work program means 3 enables the work instructor of the mobile work robot 111 to program a specific work behavior executed by the mobile work robot 111 through a GUI, a program data file manipulation by communication, or the like and stores a plurality of programmed work programs.

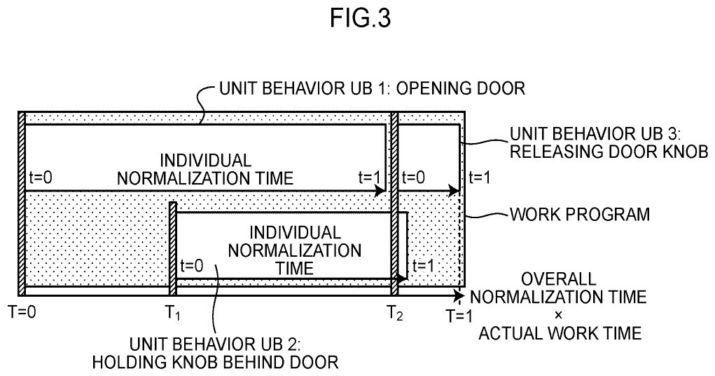

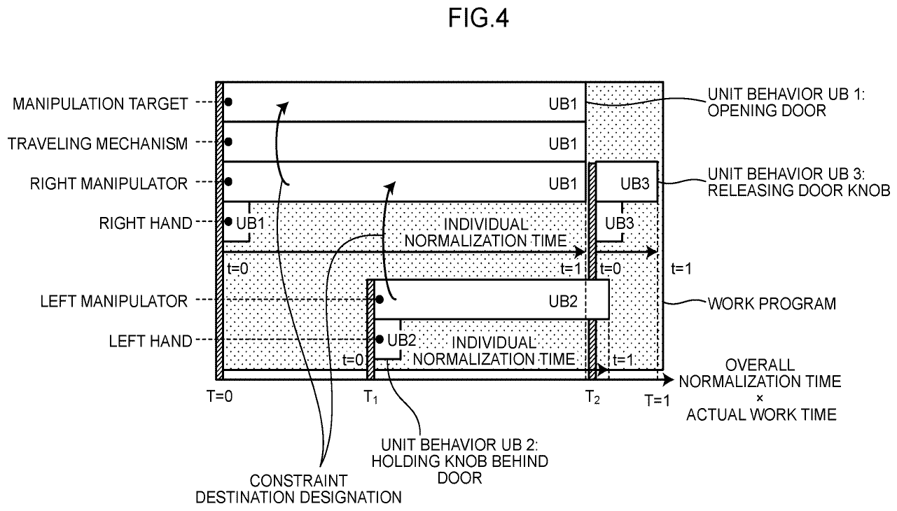

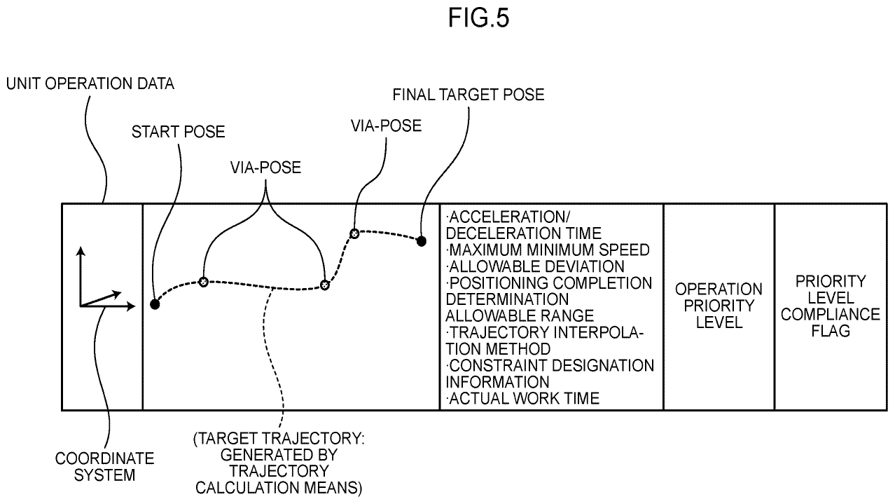

Here, the program stored in the work program means 3 is described with reference to FIGS. 3, 4, and 5. FIGS. 3 and 4 are diagrams illustrating an example of the work program stored in the control device 1 according to the present embodiment. FIG. 5 is a diagram illustrating an example of a unit operation included in the work program according to the present embodiment.

As illustrated in FIG. 3, one work program is configured with a plurality of unit behaviors. FIG. 3 is a program example of the door opening work behavior illustrated as a common example in the following description. The program of the door opening work behavior has a form in which the three unit behaviors: UB (Unit Behavior) 1. a unit behavior of opening the door, UB 2. a unit behavior of holding a knob behind the door, and UB 3. a unit behavior of releasing the door knob, are arranged on an axis of an overall normalization time obtained by normalizing the work behavior start as Time 0 and the work end as Time 1. The actual work is executed at time obtained by multiplying the overall normalization time by actual work time specified separately.

As illustrated in FIG. 4, one unit behavior is configured by adding a unit operation of each of the plurality of actuation devices configuring the mobile work robot 111 and a unit operation of the manipulation target. The mobile work robot 111 illustrated in FIG. 1 is configured with a unit operation of one manipulation target, and a unit operation of each of the traveling mechanism, the left and right manipulators (112, 113), left and right hands, and the above actuation devices.

Each unit behavior also has an individual normalization time in which the execution start of the belonging unit behavior is Time 0 and the execution end is Time 1, and the execution time of each unit operation configuring the unit behavior is defined on the individual normalization time axis. The actual behavior is executed at time obtained by multiplying the individual normalization time by an individual normalization behavior time separately designated for each unit behavior. This time is time in the overall normalized behavior time axis.

Then, the setting information to be the basis of each unit operation is pose information of the operation start time in the normalized time period, the operation start pose, at which time point in the elapsed time after the operation start, which passing pose is taken, and at which time point which final target pose is taken.

The work instructor of the mobile work robot 111 selects and designates the start pose, the passing pose, and the final target pose from the pose information group stored in the target pose teaching storage means 7. Based on the pose information, trajectory calculation means 8 calculates the trajectory of each actuation device at the time of executing the work operation. The unit behaviors can be executed in parallel as long as the actuation devices corresponding to the unit operations configuring the unit behaviors are not used at the same time.

The work instructor of the mobile work robot 111 sets the acceleration/deceleration time, the positioning completion determination allowable range, the maximum speed, the trajectory interpolation method, and the like as the unit operation. As a configuration of the unit operation, the program of each unit operation stores at least the operation start pose, the passing pose, and the final target pose of the operation amount of the joint angle and also stores the operation priority level of reaching the final target pose (see FIG. 5).

The most important and unique information among the information set for the unit operation by the work instructor of the mobile work robot 111 is constraint designation information that defines the setting of the operation priority level and how the motion of the actuation device is constrained and driven by another actuation device.

The operation priority level set by the work program means 3 is input as a default value to priority level determination means 6 described below and is adjusted in the priority level determination means 6 according to the situation. However, when the priority compliance flag is set to true, the operation priority level is not adjusted in the priority level determination means 6. When the priority level is moderated to be equal to the upper limit value, the priority level compliance flag is automatically set to true. Finally, the operation priority level is used in prioritized multi-target inverse kinematics calculation means 2.

In constraint destination designation information, first, another actuation device is designated as a constraint destination. As a result, the same coordinate system as that of the constraint destination device is set in the actuation device to be constrained. Further, a relative pose of the reference point of the actuation device with respect to the coordinate system origin of the constraint destination, and which degree of freedom among the six degrees of freedom of the motion of the actuation device is fixed with respect to the degree of freedom of the motion of the restraint destination, and which degree of freedom is driven to move are designated. The information on the fixed constraint and the movable constraint is used as a setting value of force control means 4.

The description refers back to FIG. 2. The operation execution control unit 222 includes the prioritized multi-target inverse kinematics calculation means 2, the priority level determination means 6, the trajectory calculation means 8, the force control means 4, and each axis angle limitation means 5.

The prioritized multi-target inverse kinematics calculation means 2 is solved on the assumption that there is a virtual spring between the current pose and the target pose, and each joint receives a virtual torque from the virtual spring. As a detailed embodiment of the prioritized multi-target inverse kinematics calculation means 2, a form obtained by extending the prioritized multi-target inverse kinematics solutions disclosed in Documents 1, 2, and 3 is preferable.
Document 1: Sekiguchi, Takei, “Numerical Solution of Inverse Kinematics Stable for Singular poses And Unsolvable Problems Based on Minimization of Elastic Energy of Virtual Spring”, Journal of the Robotics Society of Japan, vol. 36, no. 9, pp. 645-653, 2018.
Document 2: M. Sekiguchi and N. Takesue, Fast and Robust Numerical Method for Inverse Kinematics with Prioritized Multiple Targets for Redundant Robots, Advanced Robotics, vol. 34, no. 16, pp. 1068-1078, 2020.
Document 3: JP 2021-194734 A

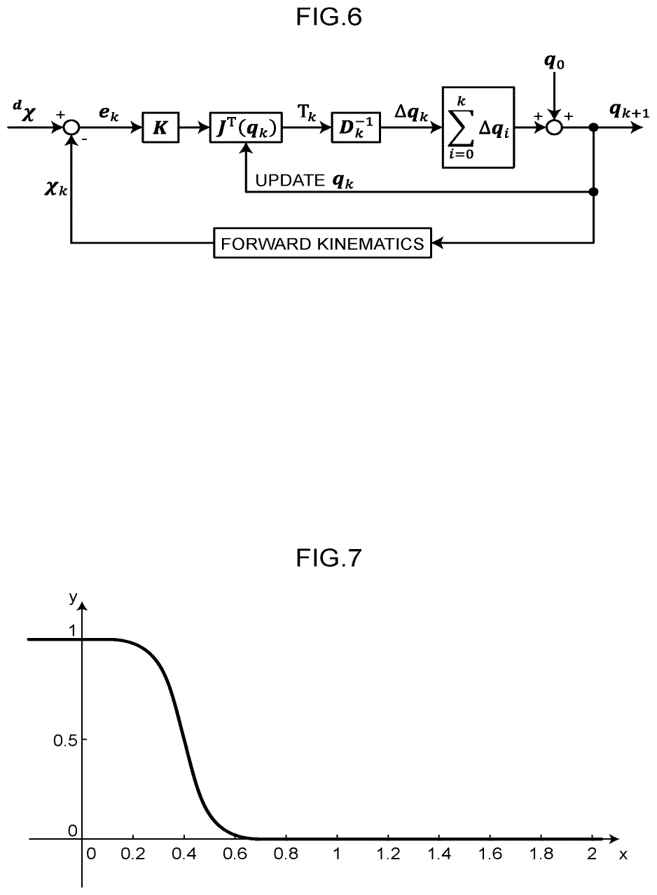

Here, FIG. 6 illustrates a block diagram of the prioritized multi-target inverse kinematics solution. In Documents 1, 2, and 3, the multi-target inverse kinematics solution is originally proposed using one manipulator as a robot modeling target. The purpose of the expansion is to change the configuration to use a mobile robot including a plurality of manipulators and a traveling mechanism as a target.

Hereinafter, the formulation of the prioritized multi-target inverse kinematics solution obtained by extending the number of the manipulators into two left and right manipulators is described in summary. In the following description, in order to simplify the description, a translational position and a rotational pose angle of each of the arm tip and the traveling mechanism are collectively referred to as a pose, and the rotation angle of the output shaft of the traveling mechanism is also referred to as joint displacement similarly to the manipulator.

In general, inverse kinematics is an arithmetic method for obtaining a joint displacement that gives a position and a pose of a manipulator arm tip. The manipulator and the traveling mechanism also have analytical solutions only for some representative forms. Meanwhile, the solution of Sekiguchi et al. is a numerical solution involving iterative calculation for minimizing the elastic energy of the virtual spring under the condition that the joint displacement has a movable range limitation.

In this solution, the inverse kinematics solution can be calculated for a robot having any structure such as a multi-degree-of-freedom manipulator or a humanoid robot in which no analytical solution exists, regardless of the number of drive shafts. Here, a calculation target of the inverse kinematics solution and one taken as an embodiment of the present idea is the mobile work robot 111 illustrated in FIG. 1 in which right and left dual arm manipulators are installed in the omnidirectional traveling mechanism as described above.

First, there is an error between the current pose and the target pose of the arm tip of each of the left and right manipulators and each of the traveling mechanisms, and a pose error vector in a total of 18 degrees of freedom is expressed as e(qₖ) using Formula (1). All of a variable e, a variable q, and a variable χ described in Formula (1) are vectors.

$$e ( {q}_{k} ) = {}^{d} χ - χ ( {q}_{k} ) \qquad Formula ( 1 )$$

q represents the joint displacement, and k represents an iterative step of iterative calculation of the inverse kinematics solution. In this formulation, three degrees of freedom of in-plane traveling are also treated as six degrees of freedom. ^{d}χ is a target pose vector of the entire mobile work robot obtained by aggregating target poses of the traveling mechanism and the left and right manipulators, and χ(qk) is a current pose vector of the entire robot obtained by aggregating current poses of the traveling mechanism and the left and right manipulators. This pose error vector is described in more detail in Formula (14) described below.

As described above, in the present solution, it is considered that there is a virtual spring between the current pose and the target pose, and each joint receives virtual torque from the virtual spring. The virtual spring coefficient matrix K∈R^{18×18} is a block diagonal matrix, and each diagonal block is an R^{6×6} virtual spring coefficient diagonal matrix of each of the left and right manipulators and the traveling mechanism. The virtual torque received by each joint from the virtual spring is given by Formula (2). All of a variable τ, the variable q, and a variable e described in Formula (2) are vectors.

$$τ ( {q}_{k} ) = {J}^{T} ( {q}_{k} ) Ke ( {q}_{k} ) \qquad Formula ( 2 )$$

J is a basic Jacobian matrix. Assuming that the velocity is generated in each joint by the damping from the virtual torque, and the damping coefficient matrix is D(qₖ), the change amount of the joint displacement at the time Δt between the iterative steps is given by Formula (3). Both of the variable q and the variable e described in Formula (3) are vectors.

$$Δ {q}_{k} = {q}_{k + 1} - {q}_{k} = Δ {tD}^{- 1} ( {q}_{k} ) {J}^{T} ( {q}_{k} ) Ke ( {q}_{k} ) \qquad Formula ( 3 )$$

As a result, the update law of the joint displacement is expressed by Formula (4). The variable q described in Formula (4) is a vector.

$${q}_{k + 1} = {q}_{k} + Δ {q}_{k} \qquad Formula ( 4 )$$

The elastic energy of the virtual spring is expressed by Formula (5). D(qₖ) is set according to Documents 1 and 2 so as to appropriately reduce the elastic energy of the virtual spring. The traveling mechanism and the right and left manipulators can be given the operation priority level to reach the target pose. This is performed by multiplying the diagonal block matrix of each of the traveling mechanism and the left and right manipulators configuring a virtual spring coefficient matrix K by a coefficient for determining the operation priority level, which is described below. Both of the variable e and the variable q described in Formula (5) are vectors.

$${V}_{k} = \frac{1}{2} {e}^{T} ( {q}_{k} ) Ke ( {q}_{k} ) \qquad Formula ( 5 )$$

As described above, the present solution method is a mathematical method of solving a kind of optimization problem using Formula (5) as an evaluation function, and the displacements of the control shafts that cause the left and right manipulators and the traveling mechanism to reach the respective target positions are collectively calculated according to the operation priority level of reaching the target position. The mobile work robot 111 illustrated in FIG. 1 has four motor drive shafts for the omnidirectional traveling mechanism and 12 motor drive shafts in total for the left and right manipulators. However, by changing the angle limit range of each shaft, the target pose of the left and right manipulators and the traveling mechanism, and the operation priority level thereof, various operations in which the manipulator and the traveling mechanism cooperate and interlock with each other can be easily generated.

Particularly, since theoretical explanation is made using a manipulator as a model in Documents 1 and 2, Formulas (2) and (3) are not sufficiently emphasized but have a very important role in this cooperative interlocking. That is, if the operation priority level of one or both of the right and left manipulators is high, and the operation priority level of the traveling mechanism is set to be lower than the operation priority level of the right and left manipulators, the traveling mechanism moves in a dependent and cooperative manner so as to prioritize the arrival of the target pose of the manipulator over the arrival of the target pose of the traveling mechanism and to reduce the target pose error of the arm tip.

As a result, the traveling mechanism is driven to move the arm tip movement of the manipulator even in the current pose maintenance, that is, in a state where the movement trajectory is not provided. This means that a traveling operation that is not taught by a person is automatically generated, and an operation that cooperatively assists the other manipulator having a high operation priority level is generated without teaching. It is needless to say that if the magnitude relationship of the operation priority level is opposite to this, the cooperative relationship or the dependency relationship between the operations of the manipulator and the traveling mechanism with respect to reaching the target pose is also reversed.

The mechanism of this cooperative operation that is an important function of the prioritized multi-target inverse kinematics calculation means 2 is described below. Therefore, Formula (2) is taken up here, and the formulation of Documents 1 and 2 is extended to target the mobile work robot 111 having the traveling mechanism and the right and left dual arm manipulators. In the following description, the expression (qₖ) is omitted from the Jacobian matrix, the error vector, and the current pose vector of the entire mobile work robot in order to avoid redundancy of the description.

First, the virtual spring coefficient matrix K and a basic Jacobian matrix J in Formula (3) are extended as in Formulas (6) and (7), respectively.

$$K = [ \begin{matrix}{K}_{V} & 0 & 0 \\ 0 & {K}_{L} & 0 \\ 0 & 0 & {K}_{R}\end{matrix} ] \qquad Formula ( 6 )$$

$$J = [ \begin{matrix}{J}_{s} & 0 & 0 \\ {J}_{s 1} & {J}_{b 1} & 0 \\ {J}_{s 2} & 0 & {J}_{b 2}\end{matrix} ] , {J}^{T} = [ \begin{matrix}{J}_{s}^{T} & {J}_{s 1}^{T} & {J}_{s 2}^{T} \\ 0 & {J}_{b 1}^{T} & 0 \\ 0 & 0 & {J}_{b 2}^{T}\end{matrix} ] \qquad Formula ( 7 )$$

Furthermore, the block matrices configuring K and J are given as Formulas (8) to (13), respectively. A variable n described in Formula (11) is a vector. Both the variable n and a variable p described in Formulas (12) and (13) are vectors.

$${K}_{V} = [ \begin{matrix}{K}_{Vx} & 0 & 0 & 0 & 0 & 0 \\ 0 & {K}_{Vy} & 0 & 0 & 0 & 0 \\ 0 & 0 & {K}_{Vz} & 0 & 0 & 0 \\ 0 & 0 & 0 & {K}_{VRx} & 0 & 0 \\ 0 & 0 & 0 & 0 & {K}_{VRy} & 0 \\ 0 & 0 & 0 & 0 & 0 & {K}_{VRz}\end{matrix} ] \qquad Formula ( 8 )$$

$${K}_{L} = [ \begin{matrix}{K}_{Lx} & 0 & 0 & 0 & 0 & 0 \\ 0 & {K}_{Ly} & 0 & 0 & 0 & 0 \\ 0 & 0 & {K}_{Lz} & 0 & 0 & 0 \\ 0 & 0 & 0 & {K}_{LRx} & 0 & 0 \\ 0 & 0 & 0 & 0 & {K}_{LRy} & 0 \\ 0 & 0 & 0 & 0 & 0 & {K}_{LRz}\end{matrix} ] \qquad Formula ( 9 )$$

$${K}_{R} = [ \begin{matrix}{K}_{Rx} & 0 & 0 & 0 & 0 & 0 \\ 0 & {K}_{Ry} & 0 & 0 & 0 & 0 \\ 0 & 0 & {K}_{Rz} & 0 & 0 & 0 \\ 0 & 0 & 0 & {K}_{RRx} & 0 & 0 \\ 0 & 0 & 0 & 0 & {K}_{RRy} & 0 \\ 0 & 0 & 0 & 0 & 0 & {K}_{RRz}\end{matrix} ] \qquad Formula ( 10 )$$

$${J}_{s} = [ \begin{matrix}{n}_{V 0} & {n}_{V 1} & 0 & 0 & 0 & 0 \\ 0 & 0 & 0 & 0 & 0 & {n}_{V 2}\end{matrix} ] \qquad Formula ( 11 )$$

$${J}_{s 1} = [ \begin{matrix}{n}_{V 0} & {n}_{V 1} & 0 & 0 & 0 & {n}_{V 2} \times ( {p}_{L} - {p}_{V} ) \\ 0 & 0 & 0 & 0 & 0 & {n}_{V 2}\end{matrix} ] \qquad Formula ( 12 )$$

$${J}_{s 2} = [ \begin{matrix}{n}_{V 0} & {n}_{V 1} & 0 & 0 & 0 & {n}_{V 2} \times ( {p}_{R} - {p}_{V} ) \\ 0 & 0 & 0 & 0 & 0 & {n}_{V 2}\end{matrix} ] \qquad Formula ( 13 )$$

Here, n represents a rotation axis vector (unit angle axis vector) of the joint, and for the traveling mechanism, rotation axis vectors of n_{V0}: translation X direction, n_{V1}: translation Y direction, and n_{V2}: the turning Z axis rotation are given by Formula (14). The variable n described in Formula (14) is a vector.

$${n}_{V 0} = [ \begin{matrix}1 \\ 0 \\ 0\end{matrix} ] , {n}_{V 1} = [ \begin{matrix}0 \\ 1 \\ 0\end{matrix} ] , {n}_{V 2} = [ \begin{matrix}0 \\ 0 \\ 1\end{matrix} ] \qquad Formula ( 14 )$$

In addition, p_{V} is a reference position of the traveling mechanism, p_{L} is an arm tip position of the left manipulator, and p_{R} is an arm tip position of the right manipulator, and the positions are given by Formula (15). The variable p described in Formula (15) is a vector.

$${p}_{V} = [ \begin{matrix}{p}_{Vx} \\ {p}_{Vy} \\ {p}_{Vz}\end{matrix} ] , {p}_{L} = [ \begin{matrix}{p}_{Lx} \\ {p}_{Ly} \\ {p}_{Lz}\end{matrix} ] , {p}_{R} = [ \begin{matrix}{p}_{Rx} \\ {p}_{Ry} \\ {p}_{Rz}\end{matrix} ] \qquad Formula ( 15 )$$

An error vector e is also obtained by detailing Formula (1) by one stage and is divided into three vectors represented by Formula (16) below: e_{V}: a pose error of the traveling mechanism, e_{L}: a pose error of the left manipulator arm tip position, and e_{R}: a pose error of the right manipulator arm tip position. Both of the variable e and the variable χ described in Formula (16) are vectors.

$$e = {}^{d} χ - χ = [ \begin{matrix}{e}_{V} \\ {e}_{L} \\ {e}_{R}\end{matrix} ] \qquad Formula ( 16 )$$

From the above, Formula (2) is extended to Formula (17) below. Both of the variable τ and the variable e described in Formula (17) are vectors.

$$τ = [ \begin{matrix}{τ}_{V} \\ {τ}_{L} \\ {τ}_{R}\end{matrix} ] = {J}^{T} Ke = [ \begin{matrix}{J}_{s}^{T} & {J}_{s 1}^{T} & {J}_{s 2}^{T} \\ 0 & {J}_{b 1}^{T} & 0 \\ 0 & 0 & {J}_{b 2}^{T}\end{matrix} ] [ \begin{matrix}{K}_{V} & 0 & 0 \\ 0 & {K}_{L} & 0 \\ 0 & 0 & {K}_{R}\end{matrix} ] [ \begin{matrix}{e}_{V} \\ {e}_{L} \\ {e}_{R}\end{matrix} ] \qquad Formula ( 17 )$$

In Formula (17), first, the virtual spring coefficient matrix K is viewed. As can be seen from Formulas (6) and (8), K that is a block diagonal matrix multiplied by the operation priority level is actually a diagonal matrix. Therefore, there is no correlation between the three actuation devices: the traveling mechanism, the left manipulator, and the right manipulator, between the different actuation devices, and between the control degrees of freedom of the different actuation devices.

Meanwhile, when looking at a transposed matrix JT of the basic Jacobian matrix that is also a block diagonal matrix in Formula (17), the three transposed block matrices in the first row represent, in order from the left, the amounts by which the translational speed and the rotational angular speed in the three-dimensional space of each of the traveling mechanism, the left manipulator arm tip, and the right manipulator arm tip contribute to the joint torque of the traveling mechanism. From this, it can be seen that the operation of the joint of the traveling mechanism has a correlation with the pose error with the target of the left and right manipulator arm tips.

Therefore, according to Formula (17) or Formula (2), it can be seen that the pose error of the left and right manipulators extends to the calculation of the drive torque of the traveling mechanism via the correlation term of JT and further the increment of the displacement amount of the traveling mechanism in Formula (3). This is further confirmed by writing down a driving torque ty of the traveling mechanism in Formula (17).

First, Formulas (11) to (13) can be written down in the following Formulas (18) to (20), respectively, by using Formulas (14) and (15).

$${J}_{s} = [ \begin{matrix}1 & 0 & 0 & 0 & 0 & 0 \\ 0 & 1 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 1\end{matrix} ] , {J}_{s}^{T} = [ \begin{matrix}1 & 0 & 0 & 0 & 0 & 0 \\ 0 & 1 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 1\end{matrix} ] \qquad Formula ( 18 )$$

$${J}_{s 1} = [ \begin{matrix}1 & 0 & 0 & 0 & 0 & - ( {p}_{Ly} - {p}_{Vy} ) \\ 0 & 1 & 0 & 0 & 0 & {P}_{Lx} - {P}_{Vx} \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 1\end{matrix} ] , \\ {J}_{s 1}^{T} = [ \begin{matrix}1 & 0 & 0 & 0 & 0 & 0 \\ 0 & 1 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ - ( {p}_{Ly} - {p}_{Vy} ) & {p}_{Lx} - {p}_{Vx} & 0 & 0 & 0 & 1\end{matrix} ] \qquad Formula ( 19 )$$

$${J}_{s 2} = [ \begin{matrix}1 & 0 & 0 & 0 & 0 & - ( {p}_{Ry} - {p}_{Vy} ) \\ 0 & 1 & 0 & 0 & 0 & {P}_{Rx} - {P}_{Vx} \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 1\end{matrix} ] , \\ {J}_{s 2}^{T} = [ \begin{matrix}1 & 0 & 0 & 0 & 0 & 0 \\ 0 & 1 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ - ( {p}_{Ry} - {p}_{Vy} ) & {p}_{Rx} - {p}_{Vx} & 0 & 0 & 0 & 1\end{matrix} ] \qquad Formula ( 20 )$$

The pose error vector refined by one step in Formula (16) is also written down by another step and expressed by Formula (21). The variable e described in Formula (21) is a vector.

$${e}_{V} = [ \begin{matrix}{e}_{Vx} \\ {e}_{Vy} \\ 0 \\ 0 \\ 0 \\ {e}_{VRz}\end{matrix} ] , {e}_{L} = [ \begin{matrix}{e}_{Lx} \\ {e}_{Ly} \\ {e}_{Lz} \\ {e}_{LRx} \\ {e}_{LRy} \\ {e}_{LRz}\end{matrix} ] , {e}_{R} = [ \begin{matrix}{e}_{Rx} \\ {e}_{Ry} \\ {e}_{Rz} \\ {e}_{RRx} \\ {e}_{RRy} \\ {e}_{RRz}\end{matrix} ] \qquad Formula ( 21 )$$

All of the first to third elements of the error vectors e_{V}, e_{L}, and e_{R} are errors of translation components in the X direction, the Y direction, and the Z direction among errors with the current pose with respect to the target pose. All of the fourth to sixth elements are components in the X direction, the Y direction, and the Z direction of an angular axis vector representing an angle error among errors from the current pose with respect to the target pose. From the above, the driving torque ty of the traveling mechanism in Formula (17) is developed as Formula (22) below. Both the variable t and the variable e illustrated in Formula (22) are vectors.

$${τ}_{V} = [ \begin{matrix}{τ}_{Vx} \\ {τ}_{Vy} \\ 0 \\ 0 \\ 0 \\ \text{?}\end{matrix} ] = [ \begin{matrix}{J}_{s}^{T} & {J}_{s 1}^{T} & {J}_{s 2}^{T}\end{matrix} ] [ \begin{matrix}{K}_{V} & 0 & 0 \\ 0 & {K}_{L} & 0 \\ 0 & 0 & {K}_{R}\end{matrix} ] [ \begin{matrix}{e}_{V} \\ {e}_{L} \\ {e}_{R}\end{matrix} ] = [ \begin{matrix}\text{?} + \text{?} + \text{?} \\ \text{?} + \text{?} + \text{?} \\ 0 \\ 0 \\ 0 \\ - \text{?} ( \text{?} - \text{?} ) + \text{?} ( \text{?} - \text{?} ) - \text{?} ( \text{?} - \\ \text{?} ) - \text{?} ( \text{?} - \text{?} ) \text{?} + \text{?} + \text{?} + \text{?}\end{matrix} ] \qquad Formula ( 22 )$$

$$\text{?} \text{indicates text missing or illegible when filed}$$

It can be certainly seen from Formula (22) that the drive torque of the traveling mechanism is affected by the error between the current pose and the target pose of the left and right manipulator arms. Therefore, the mobile work robot 111 including the control device 1 in which the prioritized multi-target inverse kinematics solution extended as described above is implemented in the prioritized multi-target inverse kinematics calculation means 2, and the prioritized multi-target inverse kinematics calculation means 2 is further incorporated can bring the arm tip closer to the arm tip target pose by the auxiliary movement of traveling even when the arm tip target pose is at a position that cannot be reached by the operation of only the manipulator.

Finally, a method of setting the priority level of the operation in the traveling mechanism, the left manipulator, the right manipulator, and the actuation device of the mobile work robot 111 is described. In order to set the operation priority level to each actuation device, the virtual spring coefficient matrix K is configured, each block diagonal matrix corresponding to the traveling mechanism, the left manipulator, and the right manipulator is multiplied by operation priority level coefficients ^{V}ξₖ, ^{L}ξₖ, and ^{R}ξₖ, respectively, and Formula (6) is rearranged as Formula (23) below.

$$K = [ \begin{matrix}{K}_{V} & 0 & 0 \\ 0 & {K}_{L} & 0 \\ 0 & 0 & {K}_{R}\end{matrix} ] = [ \begin{matrix}{}_{}^{V} {ξ}_{k}^{} {K}_{V} & 0 & 0 \\ 0 & {}_{}^{L} {ξ}_{k}^{} {K}_{L} & 0 \\ 0 & 0 & {}_{}^{R} {ξ}_{k}^{} {K}_{R}\end{matrix} ] \qquad Formula ( 23 )$$

The operation priority level coefficient is attenuated according to the number of iterations k of the inverse kinematics calculation and the degree of decrease of an elastic energy Vₖ given by Formula (5) according to the procedure described in Document 3.

The priority level determination means 6 individually adjusts the operation priority level coefficient corresponding to the operation priority of each actuation device multiplied by the spring coefficient of the virtual spring provided to each actuation device (one or more manipulators, traveling mechanism, and the like) configuring the autonomous mobile robot (sets the level of the operation priority level of each actuation device).

A collision risk determined in accordance with the distance from the periphery of the mobile work robot 111 from the collision avoidance means 9 and a recognition result of the object recognition means 11 are input to the priority level determination means 6. The output of the external sensor 10 such as a camera image can be directly given to the priority level determination means 6 as necessary.

Although not illustrated in FIG. 2, the priority level determination means 6 can acquire any control state quantity such as an angle, an angular velocity, a torque, or a current of each joint from a manipulator or a traveling mechanism. When an internal sensor such as a torque sensor for measuring joint torque is attached to the manipulator, these measurement values can also be acquired.

The priority level determination means 6 also receives, from the work program means 3, a default value of the operation priority level of a certain work operation of the mobile work robot 111 from a unit operation program of each actuation device such as a manipulator and a traveling mechanism configuring the work operation.

The priority level determination means 6 determines the priority level of the execution of the unit operation of each of the three types of actuation devices including the traveling mechanism and the right and left manipulators with respect to the input information such as the collision risk, the camera image, the control state quantity, and the default value of the operation priority level and outputs the priority level to the prioritized multi-target inverse kinematics calculation means 2.

As mapping means for determining an output with respect to an input, mapping means having any input/output relationship such as an IF-THEN type rule base system or a production rule system, a lookup table, various neural networks, a Gaussian process, various functions, a software PLC (programmable controller), a PLC of another CPU, or a combination thereof can be used. Since the robot executes a plurality of works on the premise of multipotentiality, the mapping means of the priority level output relationship with respect to the input may also be switched for each work program.

Hereinafter, on the assumption of a configuration of a composite formula of a function and an IF-THEN type rule base system, the function of the priority level determination means 6 is described by some examples for the mobile work robot 111 illustrated in FIG. 1. The operation of the prioritized multi-target inverse kinematics calculation means 2 is further clarified by the following examples.

First, the default setting and the default upper limit value setting are described. As default values, operation priority levels of the traveling mechanism that is an actuation device of the mobile work robot 111 and the right and left manipulators are input from the work program means to the priority level determination means 6. When the operation priority levels of any of the actuation devices are set to the upper limit value, the priority level determination means 6 does not change the operation priority level of the upper limit value.

That is, for the unit operation to which the priority level of the upper limit value is assigned, the change of the priority level in the priority level determination means 6 is prohibited, and the reference point of the actuation device that executes the operation is strictly controlled to reach the final target pose. In the description of specific examples including the following, the upper limit value is 1.0, and the lower limit value is 0.0.

Meanwhile, in the unit operation in which the operation priority level is from the lower limit value to the upper limit value, the reference point of the actuation device corresponding to the unit operation does not necessarily reach the final target pose, and the change of the operation priority level in the priority level determination means 6 is allowed.

Next, collision avoidance is described. It is assumed that the collision avoidance means 9 that is a component of the control device 1 of the mobile work robot 111 outputs, to the priority level determination means 6, the shortest distance value among the distance values with respect to the periphery of the mobile work robot 111 acquired by the external sensor 10 such as LiDAR together with the correction amount of the target pose of the traveling mechanism. The priority level determination means 6 adjusts the operation priority level of the traveling mechanism based on the shortest distance value.

For example, the priority level determination means 6 corrects the target position of the traveling mechanism by adding the target position correction amount given as the first output by the collision avoidance means 9. For example, the priority level determination means 6 varies the value of the operation priority level of the traveling mechanism and the manipulator multiplied by the spring coefficient according to the collision risk given as the second output by the collision avoidance means 9. An example of this adjustment method is specifically described below.

FIG. 7 illustrates an example of a case where the relationship between a shortest distance value x and an operation priority level y is expressed by Formula (24) below using a sigmoid function.

$$y = 1 - \frac{1}{1 + exp ( - 20 ( x - 0.4 ) )} \qquad Formula ( 24 )$$

According to the relational formula of Formula (24), in the region where the shortest distance value between the mobile work robot 111 and the surroundings exceeds approximately 0.8 m, the operation priority level of the traveling mechanism takes a value around 0.0 which is substantially the lower limit. Meanwhile, for a close distance at which the shortest distance value between the mobile work robot 111 and the surroundings is less than 0.1 m, the operation priority level of the traveling mechanism increases to the upper limit of 1.0.

Then, in the joint angle calculation of each actuation device in the prioritized multi-target inverse kinematics calculation means 2, the correction of the target pose calculated by the collision avoidance means 9 is performed with an operation priority level at least equal to or higher than the target arrival of another actuation device such as a manipulator. As a result, even if the traveling mechanism operates in a dependent manner with respect to the manipulator having a higher operation priority level until then, the operation of the traveling mechanism reaching the target position to which the correction amount for avoiding the collision is added becomes dominant, and the collision is avoided. That is, the program of the unit operation to which the operation priority level of the maximum limit value (1.0) is given disables adjustment of the operation priority level in the priority level determination means.

Next, generation of various behaviors is described. The various behaviors are selfish operations and altruistic operations in the door opening work. A rotary door opening operation by the mobile work robot 111 illustrated in FIG. 1 is taken as an example. It is assumed that a priority level determination rule is a rule unique to this door opening work.

Therefore, each rule does not include the condition that the door opening work is being performed. It is also assumed that the object recognition means 11 that is a component of the control device 1 of the mobile work robot 111 similarly serves as the external sensor 10 that is a component of the control device 1 of the mobile work robot 111 and can detect a person together with the manipulation target of the mobile work robot 111 based on the image captured by the three-dimensional camera 115 provided on the front side of the mobile work robot 111. Based on such an assumption, here, the following priority level determination rule is set.

IF object detection means detects a person THEN an operation priority level of the traveling mechanism=0
ELSE an operation priority level of the traveling mechanism=a default value

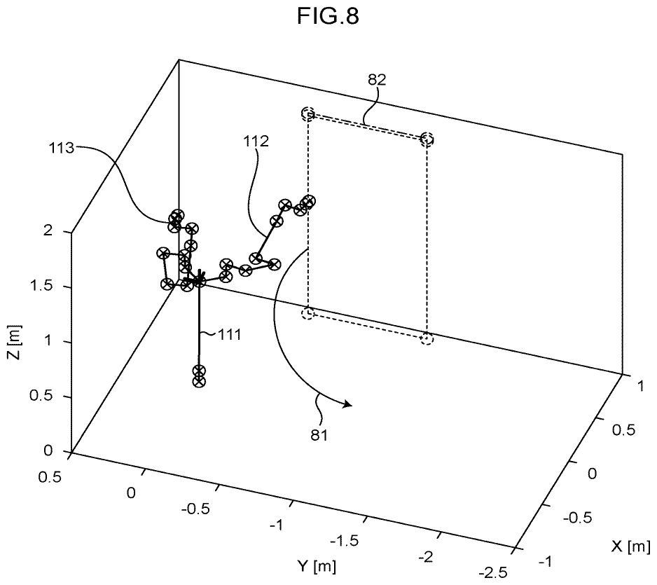

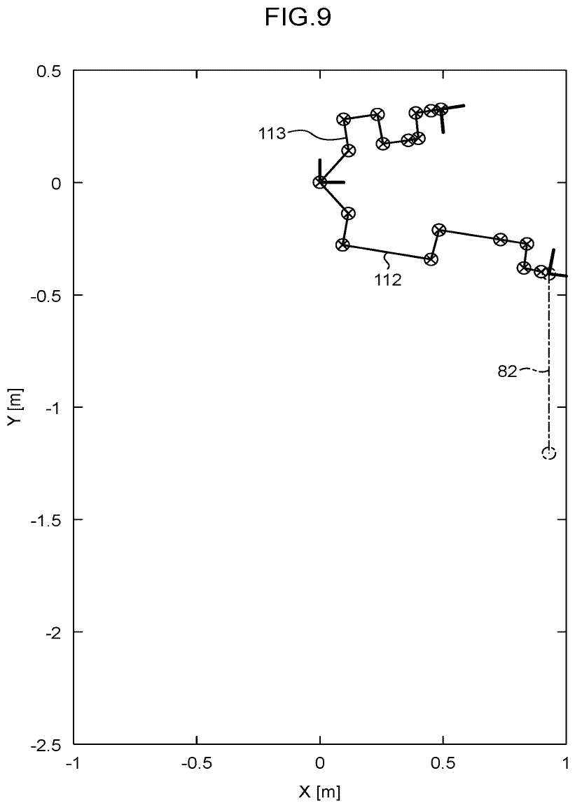

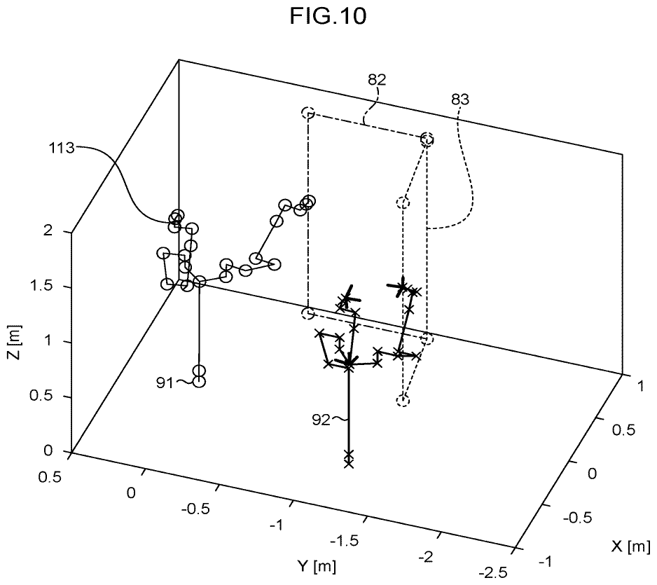

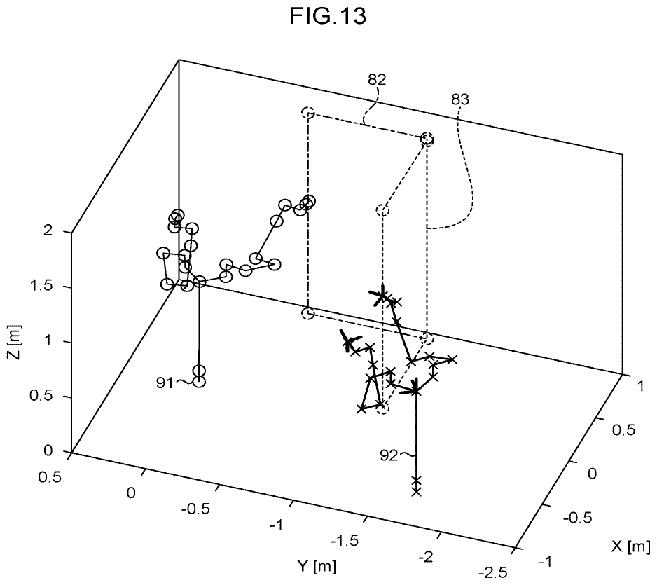

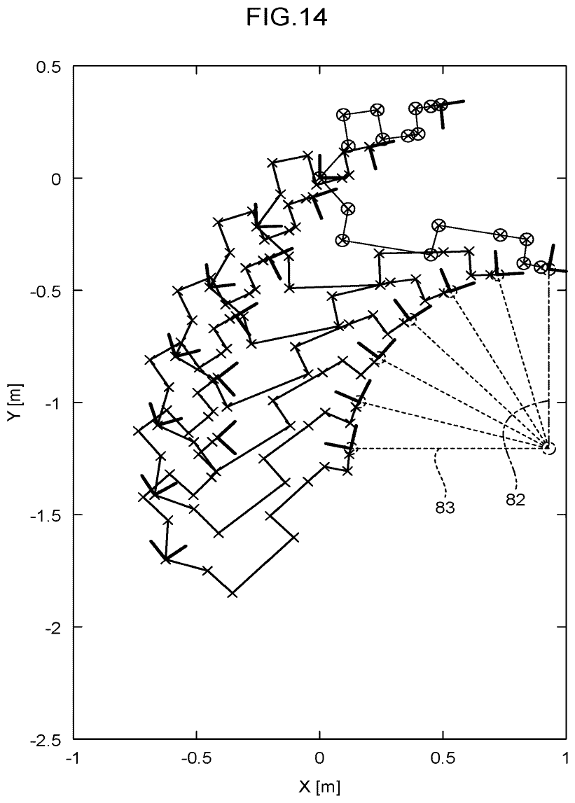

FIGS. 8 and 9 illustrate the initial state results of the simulation of a door opening operation 81 by the mobile work robot 111 with the dual arm manipulator capable of omnidirectional traveling illustrated in FIG. 1. The default value of the operation priority level of the traveling mechanism is set to 1.0, and the results of simulating the behavior of the mobile work robot 111 in the door opening work in this case are illustrated in FIGS. 10, 11, and 12. FIGS. 13 and 14 illustrate simulation results in a case where the operation priority level of the traveling mechanism is 0.

FIGS. 8 and 9 illustrate an initial state of a simulation of the door opening operation 81 performed by the mobile work robot 111 with the dual arm manipulator capable of omnidirectional traveling illustrated in FIG. 1. FIG. 8 illustrates a three-dimensional display. FIG. 9 illustrates a two-dimensional display (plan view). The door illustrated in FIGS. 8 and 9 is in a closed state 82. In FIGS. 8 and 9, the mobile work robot 111 is represented by a skeleton link model, and the length and attachment angle of each link configuring this model are in accordance with the design values of the mobile work robot 111 illustrated in FIG. 1.

The following simulation simulates an operation in which the mobile work robot 111 opens the door in a state in which the arm tip of the right manipulator 112 is fixed to a door knob or a door handle corresponding portion. The operation of releasing the door by twisting the door knob or the door handle is not considered, and it is assumed that the door is unlocked or released.

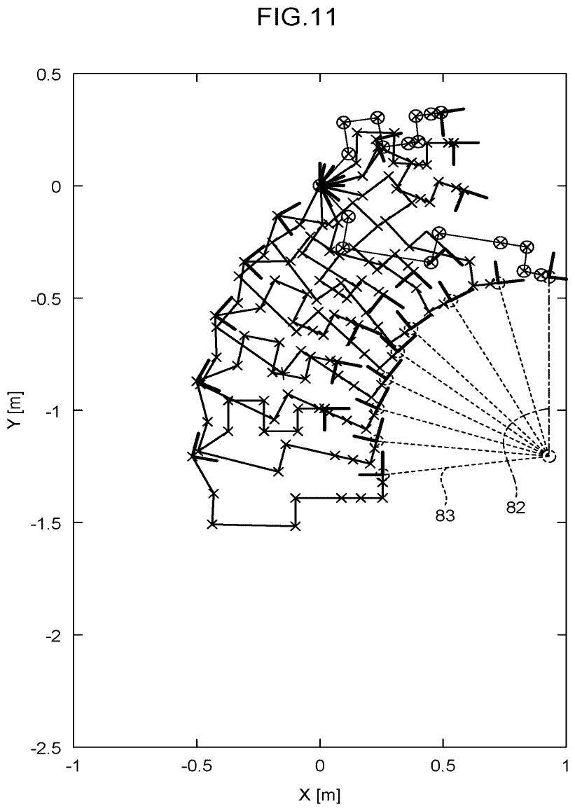

FIG. 10 illustrates the pose of the mobile work robot 111 in an initial state 91 and an end state 92 of the simulation when the operation priority level of the traveling mechanism is set to 1.0. FIG. 11 illustrates a change in the pose of each of the left and right manipulators and the traveling mechanism from the initial state 91 to the end state 92. The door illustrated in FIGS. 10 and 11 illustrates a closed state 82 and an open state 83 including a case of transition to an end state. Referring to FIGS. 10 and 11, in the end state 92, the mobile work robot 111 is positioned slightly to the right with respect to the front surface of the door opening. Therefore, when the mobile work robot 111 passes through the door opening, it can be said that the mobile work robot is positioned at a place where the mobile work robot itself easily passes through the door opening.

In this simulation, it is assumed that a person gives a pose of the right hand end in each state in which the door is opened by 15° with respect to the initial state. Meanwhile, the pose of the traveling mechanism is given by neither teaching nor calculation.

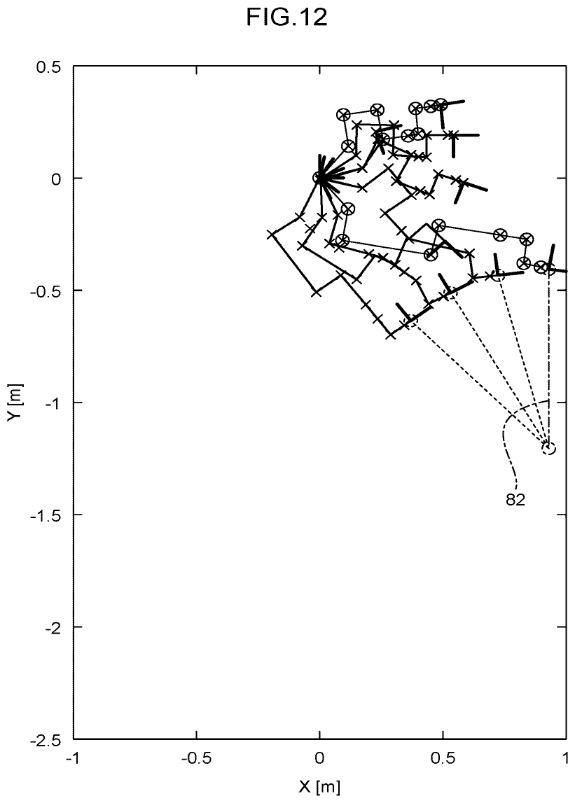

FIG. 12 illustrates a pose change of the mobile work robot 111 from the initial state 91 to immediately before the traveling mechanism starts to move. From the initial state 91 to the state in this drawing in which the door is opened by 45°, the traveling mechanism only turns clockwise, and the positions in the X and Y directions are maintained at the same positions as in the initial state. Then, in the state of FIG. 12, the joint angle of the fourth joint and the joint angle of the fifth joint reach the limit of the movable range, and as a result, the right manipulator arm tip cannot move any more.

In the subsequent state, the traveling mechanism having a lower operation priority level also starts translational movement in the X and Y directions so as to assist the right manipulator arm tip having a higher operation priority level to reach the target pose by the action of the prioritized multi-target inverse kinematics calculation means 2. As a result, as illustrated in FIG. 11, it can be seen that the tip of the right hand continues the operation of opening the door, and the door is opened by about 90° with respect to the initial state 91.

FIG. 13 illustrates the pose of the mobile work robot 111 in an initial state 91 and an end state 92 of the simulation when the operation priority level of the traveling mechanism is set to 0. FIG. 14 illustrates a change in the pose of each of the left and right manipulators and the traveling mechanism from the initial state 91 to the end state 92. Referring to FIGS. 13 and 14, in the end state 92, the mobile work robot 111 is positioned at a place deviated to the right side from the front surface of the door opening. From this place, it is difficult for the mobile work robot to pass through the door opening by itself, but other people and other mobile work robots easily pass through the door opening.

As can be seen from these simulation results, the mobile work robot 111 that grips the door handle with the right manipulator and the hand and opens the door generally faces the opening direction of the door. For this reason, it can be considered that the camera that is provided on the front side of the mobile work robot 111 and has a viewing angle of about several tens of degrees normally captures an image of the periphery of the opening while the mobile work robot 111 executes the door opening operation.

Therefore, it is appropriate to consider that the condition portion of the priority level determination rule is a case where the object detection means detects a person around the door opening. In view of both simulation results under this premise, according to the present priority level determination rule, when the object recognition means 11 does not detect a person in the door opening while the door is being opened, the mobile work robot 111 takes a selfish behavior to stay in front of the door opening. Meanwhile, when the object recognition means 11 detects a person while the door is being opened, the object recognition means takes an altruistic behavior to give way to a person passing through the door.

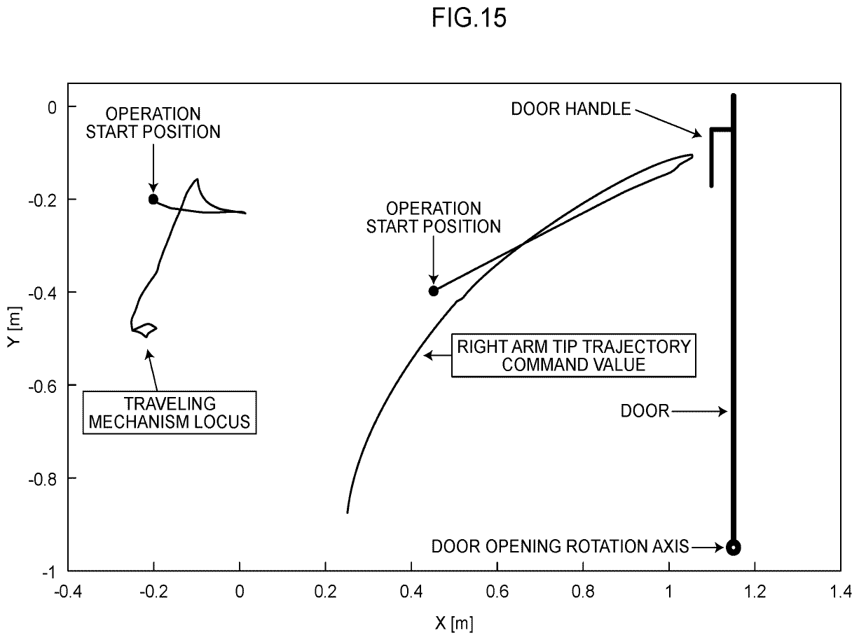

FIG. 15 illustrates a result of performing the door opening operation with the actual machine of the mobile work robot 111 illustrated in FIG. 1. In this trial, the person teaches the arc-shaped trajectory of the right manipulator arm tip at the time of opening the door as a start point, an end point, and two intermediate via-points. The trajectory is generated by curve interpolation of these four points. The traveling mechanism is automatically interlocked to the right manipulator with the operation priority level set to 0.

FIG. 15 illustrates a locus of the movement command value of the right manipulator arm tip at this time and a movement locus of the traveling mechanism automatically interlocked with the right manipulator. As can be seen from the latter, when the right hand goes to hold the door handle, the arm tip moves forward by about 0.2 m so as to reach the door handle. Next, after the door is started to be opened, the elbow of the right manipulator that pulls the door handle enters the interference region of the body 114 of the mobile work robot 111, but it can be seen that the traveling mechanism is retracted by about 0.12 m in order to pull the door handle while avoiding this.

When the right hand that needs to move in an arc shape to the right when the door is viewed from the front tries to keep holding the door handle, the right manipulator gradually takes an unnatural form, and the plurality of joints reach the limit of the movable range. However, when the locus of the second half of the traveling mechanism is viewed, it can be seen that the right manipulator moves by about 0.4 m to the right side corresponding to the negative side of the Y axis while moving backward by about 0.2 m to the negative side of the X axis. This is a result of movement of the traveling mechanism to assist tracking of the target trajectory of the right hand that has reached the movable range limit and is no longer movable during the operation.

Finally, the mobile work robot 111 can open the door to nearly 90°. As described above, the traveling mechanism draws a complicated movement locus, but it can be understood that there is a considerable difficulty in teaching such movement by a person while coping with the movable range limit of the manipulator.

Note that, in a case where the operation priority level of the traveling mechanism for avoiding collision exceeds the operation priority level of the manipulator or in a case where the external force estimation value of the arm tip holding the door handle indicates a high value, the arm tip is separated from the door handle and is separated from a nearby target at risk of collision, or a high load of the arm tip is released. In this case, continuity of the teaching work is emphasized by starting retry without generating an operation error as much as possible.

Meanwhile, when the manipulator sets the upper limit priority to 1.0, and then the collision avoidance exceeds the operation priority level, or the external force estimation value of the arm tip holding the door handle indicates a high value, the door handle is not released. As a result, the arm tip estimated external force and the joint torque become a high load exceeding the threshold, and the external sensor 10 and the interface unit of the internal sensor of the control device 1 of the mobile work robot 111 are more likely to output an operation error.

In this case, the priority level determination means 6 sets the operation priority level coefficient of the traveling mechanism to a high value of 0 to 1 and sets the operation priority level coefficient of the manipulator to 0 when the work program executed at a certain work position has contents of only the wide area travel movement of the traveling mechanism and no operation execution of the manipulator, and sets the operation priority level coefficient of the manipulator to be higher than the operation priority level coefficient of the traveling mechanism when the work program includes the operation execution of the manipulator.

Next, securing of safety in assisting the manipulator to reach the target pose by the traveling movement is described. The priority level determination means 6 determines whether the target pose of the arm tip of the manipulator is out of the operation range of the manipulator and adjusts the operation priority level of the traveling mechanism to a lower limit value to suppress the operation of the manipulator, when the target pose is out of the range.

For example, the priority level determination means 6 determines whether the arm tip target pose is out of the operation range of the manipulator and sets the operation priority level of reaching the target pose of the traveling mechanism to 0 when the target pose is out of the operation range. Then, since the traveling mechanism completely travels toward the target pose of the manipulator arm tip, the amount of movement of the manipulator to bring the arm tip close to the target pose relatively decreases.

If the traveling mechanism and the manipulator arm tip have the same operation speed, the manipulator does not need to move. As a result, it is possible to suppress traveling with the manipulator fully extended even though the object is not operated.

As a method of achieving safety, in addition to setting the operation priority level of the traveling mechanism to 0, the speed of the manipulator is set to 0, the execution time of the manipulator unit operation (the actual work time illustrated in FIGS. 3 and 4) is set to a maximum value, and the Jacobian matrix row of the manipulator is set to 0.

As described above, in the control method of the mobile work robot 111 according to the present invention, only by setting or changing the operation priority level of the actuation device such as the traveling mechanism or the manipulator, it is possible to cause the robot itself to generate various operations similar to the behavior of the person without teaching or learning by the action of the prioritized multi-target inverse kinematics calculation means 2.

This operation generation is performed by the prioritized multi-target inverse kinematics calculation means 2 calculating a joint angle that brings each actuation device as close as possible to the target pose while following a plurality of constraints such as a motion constraint of a manipulation target such as a door, a constraint of a distance to the surroundings, and a constraint of a movable range of each joint of the robot itself.

At this time, by flexibly changing the operation priority level of each actuation device according to the situation, the priority level determination means 6 plays a role of causing the mobile work robot 111 to take a behavior that achieves both safety meeting the various constraints described above and a purpose of work achievement.

At the time of execution of the work operation, the trajectory calculation means 8 calculates the trajectory of each actuation device, that is, time-series data of the target pose in each control period that changes temporally and is spatially continuous. In the mobile work robot 111 illustrated in FIG. 1, the actuation devices are the traveling mechanism, the left and right manipulators (112, 113), and the left and right hands.

After being set and stored by the target pose teaching storage means 7, the trajectories of these actuation devices are calculated by interpolating the poses selected as the start point, the via-point, and the final target point of the operation in the work program means 3 based on the interpolation method similarly designated in the work program means 3. Generally, there are types of interpolation methods such as linear interpolation, circular interpolation, and free curve interpolation using a B-spline curve, a NURBS curve, a clothoid curve, or the like.

The trajectory calculation means 8 is configured with a technique used in a robot in the related art, but a form of setting the pose of the final target or the via-target in the trajectory calculation means 8 is greatly different from a setting form in the robot in the related art in which it is necessary to strictly and sequentially set the pose to be followed by the actuation device configuring the robot.

That is, the setting of the pose in the trajectory calculation means 8 according to the present embodiment may be setting so that the target pose is not set for a certain actuation device for a certain period of time or the entire period of time during the work operation of the entire mobile work robot, and as a result, the pose at the time of starting the work operation is maintained. Alternatively, the setting may be the setting of rough trajectory generation so as to linearly move toward the final target pose simply determined roughly.

In the present embodiment, such a setting is actively allowed or utilized. That is, for an actuation device having a low operation priority level, even if detailed trajectory data is not given through teaching or learning by a person, a trajectory is automatically generated in the form of following or assisting the actuation device having a high operation priority level. The mechanism of generating the trajectory or the operation is based on the action of the prioritized multi-target inverse kinematics calculation means 2 described below.

Next, the force control means 4 is described. In the simulation example of the door opening operation illustrated in FIGS. 8 to 14, the target pose along the arc trajectory of the arm tip of the right manipulator 112 with a high priority level when opening the door is given in advance by teaching or calculation in increments of 15°.

In this case, even if it is not necessary to teach the pose of the traveling mechanism having a low priority level or it is only necessary to teach the final target pose, teaching and preliminary calculation are still complicated. In order to solve this problem, the force control means 4 plays a role of dramatically reducing the amount of precalculation of teaching and operation planning even for the target pose of the manipulator arm tip set to a high priority level. Hereinafter, the configuration of the force control means 4 is described.

The force control method of the manipulator used in the force control means 4 may be any one of admittance control, compliance control, and impedance control. Here, the admittance control is taken as an example, and a specific example is described.

If the movement of the manipulation target of the manipulator is constrained like a hinge of a rotary door or sliding of a sliding door, when the movement of the manipulator is roughly taught, the manipulation target cannot move as taught, and the manipulator may receive an excessive external force.

In such a case, the external force is relaxed by the admittance control law based on the external force estimated by the external force estimation means. First, an external force estimation method used for estimating an external force of the manipulator of the mobile work robot 111 illustrated in FIG. 1 is described. The general dynamics equation of the manipulator is then expressed by Formula (25). A variable θ, a variable g, a variable r, and the variable τ shown in Formula (25) are all vectors.

$$H ( θ ) \ddot{θ} + C ( θ , \dot{θ} ) \dot{θ} + g ( θ ) + r ( \dot{θ} ) = {τ}_{m} - {τ}_{e} \qquad Formula ( 25 )$$

θ is the joint displacement, the first term on the left side of the formula is an inertia term, the second term is a centrifugal force/Coriolis force term, the third term is a gravity term, the fourth term is a friction term, the right side τₘ is a motor torque, and τₑ is an external force torque. Assuming use at a relatively low speed, the influence of inertia and centrifugal force/Coriolis force is considered to be small (substantially equal to 0), and the external force estimation torque is estimated by Formula (26). The variable τ, the variable g, the variable r, and the variable θ illustrated in Formula (26) are all vectors.

$${\hat{τ}}_{e} = {τ}_{m} - g ( θ ) - r ( \dot{θ} ) \qquad Formula ( 26 )$$

The motor torque on the right side can be detected, and the gravity term and the friction term are determined from the physical quantity of the manipulator and the mechanical characteristic of the drive system. These constants are identified in advance. From this external force torque, the arm tip external force Fe is estimated by Formula (27) without using the force sensor. Both the variable θ and the variable t shown in Formula (27) are vectors.

$${F}_{e} = {J}^{- T} ( θ ) {\hat{τ}}_{e} \qquad Formula ( 27 )$$

J(θ) represents a basic Jacobian matrix. Since the estimated value includes uncertainty, a value exceeding the threshold value is set as the arm tip estimated external force. The admittance control is performed using the arm tip estimated external force. When the virtual spring damper system is set on the manipulator arm tip, the arm tip target position correction amount Δp to be obtained follows the dynamics of Formula (28) below. The variable p shown in Formula (28) is a vector.

$${\hat{F}}_{e} = M Δ \ddot{p} + D Δ \dot{p} + K Δ p \qquad Formula ( 28 )$$

M represents inertia, D represents viscosity, and K represents elasticity. The arm tip target position correction amount Δp is calculated from the arm tip estimated external force by Formula (28). Here, the sensorless external force estimation method that is adopted by the mobile work robot 111 illustrated in FIG. 1 and that simplifies the hardware is described. However, the external force may be directly detected by a force sensor for detecting or estimating the arm tip estimated external force.

In the force control, it is generally necessary to set which degree of freedom among the six degrees of freedom of motion of the actuation device is fixedly constrained and which degree of freedom is driven to move. As described above, the information on the fixed constraint and the movable constraint is set to the unit operation of the actuation device stored in the work program means 3.

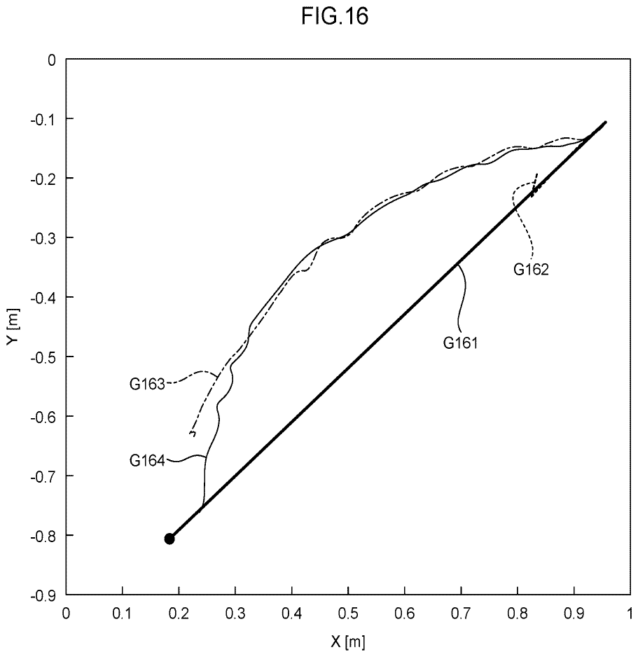

FIG. 16 illustrates a locus of the right hand gripping and moving the door handle in the door opening operation. By using the actual mobile work robot illustrated in FIG. 1, it is verified whether the admittance control can correct the trajectory to an arc-shaped trajectory while suppressing the generation of excessive force by teaching the operation of the mobile work robot 111 to open the door with the right hand to draw the door handle in an obliquely linear manner with the pose in which the right hand finished opening the door as a target (end point).

A graph G161 is a target trajectory in which the end point is taught by data. The locus of the right hand (graph G162) when the admittance control is not corrected stops at a point advanced by about 0.1 m along the target trajectory. This is because the traveling mechanism in which the current pose is set to the target pose with a low priority level receives a force relatively pulled by the manipulator moving the arm tip to linearly open the door, and as a result, the traveling mechanism abnormally stops due to overload.

Next, when rotation Rz about the Y axis and the Z axis is corrected (163), the locus is substantially arc-shaped, but the door is not opened up to the angle of the end point. Further, by correcting the X direction, the door is opened to an end point corresponding angle (graph G164).

The function of force control such as admittance control described herein is also a function provided in an industrial robot in the related art but has more important significance for operation teaching in the mobile work robot 111 in which the manipulator is installed on the traveling mechanism targeted by the present invention.

That is, in teaching the arm tip pose of the manipulator installed on the traveling mechanism, it is necessary to determine in advance the pose of the traveling mechanism with respect to the manipulation target. It is troublesome to remove the body 114 one by one when the arm tip pose is taught, but this trouble is alleviated by roughly teaching the arm tip pose by the force control function. By adding the admittance control, the occurrence of overload is suppressed, and the door opening operation is realized.

Next, each axis angle limitation means 5 is described. When the arm tip of the manipulator is moved to the next target pose, a new joint angle to give the next arm tip target pose calculated by the prioritized multi-target inverse kinematics calculation means 2 is individually input to each axis angle limitation means 5.

Each axis angle limitation means 5 determines whether the input joint angle of each of the left and right manipulators falls within the interference region between the manipulator and the body 114 of the mobile work robot 111 and returns the determination result to the prioritized multi-target inverse kinematics calculation means 2 individually for the left and right as true: no interference or false: interference.

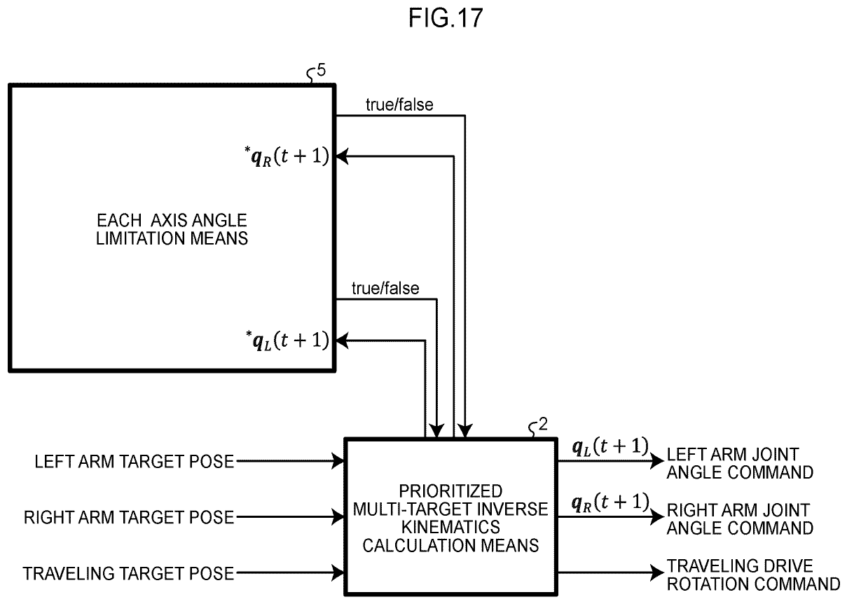

FIG. 17 is a block diagram illustrating an example of information input/output between the prioritized multi-target inverse kinematics calculation means 2 and each axis angle limitation means 5. The prioritized multi-target inverse kinematics calculation means 2 calculates new joint angles *q_{L}(t+1) and *q_{R}(t+1) that give the arm tip target pose in the next control period t+1 for each of the left and right manipulators in a certain control period t.

Each axis angle limitation means 5 determines whether the input joint angles *q_{L}(t+1) and *q_{R}(t+1) of each of the left and right manipulators falls within the interference region between the manipulator and the body 114 of the mobile work robot 111 and returns the determination result to the prioritized multi-target inverse kinematics calculation means 2 as true: no interference or false: interference.

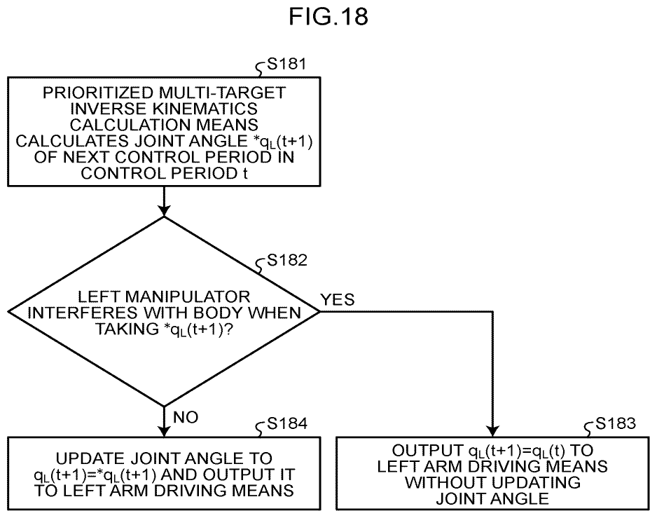

Meanwhile, when the new joint angle of the manipulator to be taken in the next control period t+1 calculated in the control period t deviates from the movable angle range of the manipulator or when each axis angle limitation means 5 determines that the new joint angle falls within the interference region, the prioritized multi-target inverse kinematics calculation means 2 does not update the joint angle target command value to the new joint angle of the manipulator and maintains the joint angle target command value of the previous calculation period. The flow of this determination processing is illustrated in the flowchart of FIG. 18.

FIG. 18 illustrates a flow of output determination of the joint angle target command value related to the left manipulator in the prioritized multi-target inverse kinematics calculation means 2. The prioritized multi-target inverse kinematics calculation means 2 calculates a new joint angle *q_{L}(t+1) of the left manipulator to be taken in the next control period t+1 calculated in the control period t (step S181) and does not update the joint angle target command value to the new joint angle *q_{L}(t+1) of the manipulator, but maintains the joint angle target command value q_{L}(t) in the previous calculation period (step S183), when the joint angle deviates from the movable angle range of the manipulator, or determined to fall with the interference region by each axis angle limitation means 5 (step S182: Yes). The same determination processing is performed on the right manipulator in each control period.

As a result, it is possible to prevent the link attached to the rotation side of a certain joint of the manipulator from colliding with the link on the fixed side or the manipulator from colliding with the body 114 of the mobile work robot 111 as a result of the joint being operated beyond the movable range.

Next, an example of a specific embodiment of each axis angle limitation means 5 is described. Each axis angle limitation means 5 stores either the movable angle range of the joint of the manipulator, the joint of the manipulator angle range in which the manipulator interferes with the body 114 of the mobile work robot 111, or the joint of the manipulator angle range in which the manipulator does not interfere with the body 114 of the mobile work robot 111, or both the joint of the manipulator angle range in which the manipulator interferes with the body 114 of the mobile work robot 111 and the joint angle range in which the manipulator does not interfere.

Alternatively, each axis angle limitation means 5 may not store the interference region or the non-interference region at all and may calculate (determine in real time and check interference) the presence or absence of interference between the manipulator and the body of the mobile work robot 111 based on the shape data of each of the manipulator and the body every time when the joint angle of the manipulator is given.

However, since the processing amount of this calculation is generally large, and time is required for the calculation, in the description of the specific embodiment of each axis angle limitation means 5, it is assumed that each axis angle limitation means 5 stores both the movable angle range of the joint of the manipulator and the joint angle range in which the manipulator interferes with the body 114 of the mobile work robot 111 and the joint angle range in which the manipulator does not interfere with the body 114.

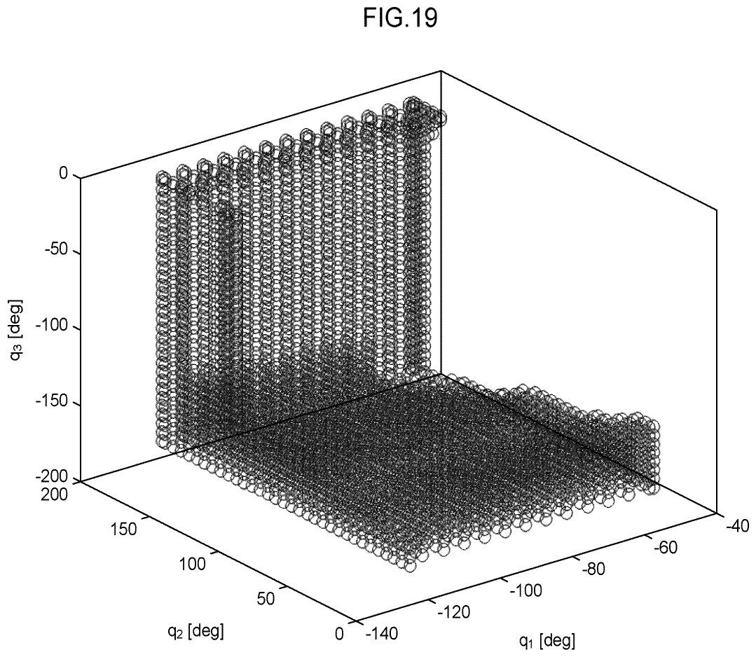

FIG. 19 is a three-dimensional graph illustrating the interference region between the left manipulator 113 and the body 114 in a joint space of three axes of the left manipulator 113 on a base portion side in the mobile work robot 111 illustrated in FIG. 1. FIG. 19 is a three-dimensional graph of the mobile work robot 111 illustrated in FIG. 1, in which regions where the left manipulator and the body 114 of the mobile work robot 111 interfere with each other within the movable ranges of the three axes on the base side of the left manipulator 113 are analyzed by simulation based on the three-dimensional shape model and plotted with circles.

Here, a base portion 117 refers to a base seat portion (base installation portion) of the shoulder of the left manipulator 113. Three coordinate axes q₁, q₂, and q₂ in FIG. 19 represent the rotation angles of the joint axes of the first axis A1, the second axis A2, and the third axis A3, in the order of proximity to the base portion 117. The presence or absence of interference between the manipulator and the body 114 is analyzed by calculation by changing each of these three axes by 5°, and FIG. 19 is plotted.

This is equivalent to representing the interference region with cube cells in increments of 5° angle division. When circles are assigned to three sets (q₁, q₂, q₃) of a certain joint angle, it may be determined that the manipulator and the body 114 roughly interfere with each other with respect to the joint angles included in the range of ±2.5° from (q₁, q₂, q₃). When the presence or absence of interference is more precisely analyzed by further reducing the angle division step, the manipulator can be brought closer to the body 114.

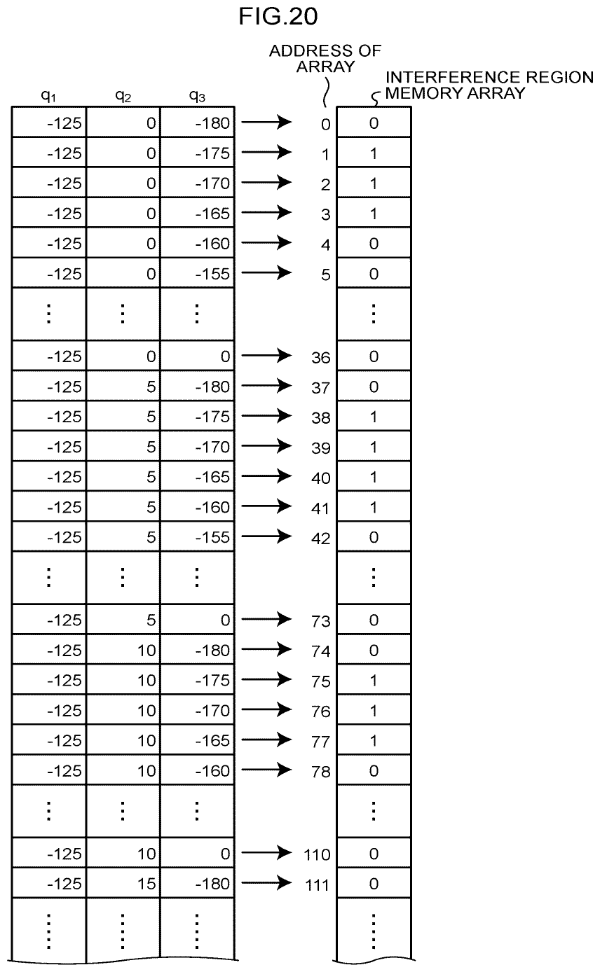

Each axis angle limitation means 5 in the control device of the mobile work robot 111 in the example stores this information in the memory array. That is, the example of FIG. 13 illustrates the interference angle range and the non-interference angle range in increments of 5° with respect to the joint angles of the three axes of the manipulator on the base side of the mobile work robot 111 illustrated in FIG. 1, but the memory array in this case has a configuration as illustrated in the schematic diagram of FIG. 20.

FIG. 20 is a schematic diagram illustrating the configuration of the memory array in which the interference region and the non-interference region are stored and the relationship between the memory array and the joint angles (q₁, q₂, q₃) of the three axes of the left manipulator on the base portion included in each axis angle limitation means 5 for the left manipulator of the mobile work robot 111 illustrated in FIG. 1.

In the stored values of each cell of the memory array, 1 represents an interference state, 0 represents a non-interference state, and information corresponding to the three-dimensional graph of FIG. 19 is stored in the entire memory array. When the joint angles (q₁, q₂, q₃) Of the three axes of the manipulator on the base portion are given, the address in the memory array can be easily calculated from the joint movable range and the angle division increment of each of the three axes, and whether the joint angle is in the interference region is determined from the stored value of the cell in the memory array corresponding to the address.

Then, in FIG. 13, 1 is stored in the cells of the memory array corresponding to the three sets of the joint angles plotted with circles, and 0 is stored in the cells of the memory array corresponding to the three sets of the joint angles not plotted with circles. Here, for the sake of convenience of illustration in addition to the suppression of the amount of calculation, the joint space of only the base three axes is targeted, and the interference region is stored using a memory corresponding to a lattice cell, but the present invention is not limited thereto.

That is, it is originally desirable that the joint space is configured in a dimension corresponding to the number of joint axes of the manipulator. The method of storing the interference region may be a method such as a neural network that is applied in the related art.

When the CPU of the control device 1 of the mobile work robot 111 has high performance and is sufficient for the amount of calculation, neither the interference region nor the non-interference region is stored as described above. When the joint angle of the manipulator is given, the presence or absence of interference between the manipulator and the body of the mobile work robot 111 may be calculated every control period based on the shape data of the manipulator and the shape data of the body 114.

As described above, the control device 1 of the autonomous mobile robot of the present embodiment performs calculation (solution) on the assumption that there is a virtual spring between the current pose and the target pose, and each joint receives virtual torque from the virtual spring, and individually adjusts the operation priority level coefficient corresponding to the operation priority level of each actuation device multiplied by the spring coefficient of the virtual spring, the operation priority level coefficient which is individually given to the actuation devices configuring the autonomous mobile robot.

The control device 1 of the autonomous mobile robot of the present embodiment avoids collision based on the distance measurement value with the surroundings, corrects the target position of the traveling mechanism by adding the target position correction amount, and varies the values of the operation priority levels of the traveling mechanism and the manipulator, the values which are multiplied by the spring coefficient of the virtual spring, according to the collision risk.

For example, in the mobile work robot provided with the right and left dual arm manipulators, due to the prioritized multi-target properties of the solution of the prioritized multi-target inverse kinematics calculation means 2 incorporated in the control device 1, even if the arm tip target positions of the right and left manipulators are different from each other, and even if the final target pose of the arm tip is present at a position where the arm tip of the manipulator does not reach, if the final target poses of the arm tips of the both manipulator arms are roughly taught, and the operation priority level of the traveling mechanism is set to be smaller than those of the both manipulators, the traveling mechanism is interlocked so that the movements of the both manipulators are also achieved even if the same final target pose as the current pose is given.

As a result, it is possible to execute a complicated work that is difficult to teach by the mobile work robot in the related art and requires simultaneous and separate movement of the manipulator and traveling, for example, an operation of starting to open the door with the manipulator arm tip and then continuing to open the door by further moving the arm tip while retracting the traveling mechanism. According to the results of the simulation and the actual machine operation illustrated in FIGS. 10 to 15 described above, it can be seen that such a movement caused by the prioritized multi-target inverse kinematics calculation means 2 is realized.

Furthermore, a high operation priority level can be assigned not only to the manipulator but also to the traveling mechanism. Then, since the traveling mechanism maintains the target pose or tries to move toward the target pose, if this target pose is corrected according to the distance from the surroundings, the traveling mechanism can perform cooperative interlocking traveling so as to assist the manipulator having a high operation priority level to reach the target pose while preventing collision with the surroundings.

From the above, for example, even when a large number of placement positions are designated for the manipulator as in product replenishment in a convenience store or a supermarket, only the arm tip position of the manipulator with respect to each of the placement positions may be only taught or set, and it is not necessary to individually teach vehicle body stop positions (it is not necessary to teach the traveling stop position and teach the traveling operation). As a result, the teaching time of the work is shortened.

For example, the control program stored in the work program means has a format in which programs of unit operations of individual actuation devices of the mobile work robot 111 such as a manipulator, a traveling mechanism, and a hand are executed in parallel. The program of each unit operation stores at least the operation start pose, the passing pose, and the final target pose of the operation amount of the joint angle and also stores the operation priority level of reaching the final target pose.

In these unit operation programs, if the operation priority level of the manipulator is set higher than the operation priority level of the traveling mechanism, the parallel execution of each unit operation is enabled, and the traveling mechanism moves to assist the target arrival of the manipulator arm tip, and therefore is not necessary stopped each time to start moving the manipulator.

As a result, specifically, it is possible to execute a work of picking up the suitcase flowing on the baggage conveyor of the airport while tracking the suitcase, and the execution time of various works is shortened. According to the prioritized multi-target properties of the solution in the prioritized multi-target inverse kinematics calculation means 2 as in the case of the door opening, the traveling mechanism can travel so as to assist the movement of the manipulator picking up the suitcase while tracking the suitcase, and at the same time, travel so as to prevent the collision with the conveyor (the manipulator can go to pick up a merchandise and a product while traveling).

The control device 1 of the autonomous mobile robot according to the present embodiment has a force control function based on any control law among admittance control, compliance control, and impedance control in a control unit of a manipulator.

For example, the autonomous mobile robot in which the manipulator is installed in the body 114 on the traveling mechanism as illustrated in FIG. 1 is considered. It is assumed that, when the manipulator of the mobile work robot 111 manipulates an object having a motion constraint such as a door (hinged door) in which a motion other than rotation is constrained with the arm tip along the taught trajectory, in order to avoid collision with an approaching person or some other object, the operation priority level of the traveling mechanism is increased to a level the same as or higher than the operation of the manipulator.

As a result, when the body 114 of the mobile work robot 111 that is stopped at the time of the work teaching starts traveling movement, the body 114 of the mobile work robot 111 on which the manipulator base portion is installed moves. Therefore, the arm tip trajectory with respect to the manipulator base relatively is deviated from the trajectory set by the initial teaching or learning. In this case, in the technique in the related art, the manipulator stops due to overload.

Meanwhile, in the present embodiment, even from the middle of the operation of the object having the motion constraint that operates only the manipulator without traveling movement, when the collision avoidance means 9 adds the pose correction amount of the traveling mechanism to the pose target value of the traveling mechanism, and the priority level determination means 6 gives a value larger than the lower limit value of 0 to as the operation priority level of the traveling mechanism unit, the prioritized multi-target inverse kinematics calculation means 2 works to establish both the collision avoidance by the pose target value correction of the traveling mechanism and the originally executed object manipulation.

That is, as a result of the traveling mechanism avoiding the collision between the body 114 and the surroundings, the manipulator arm tip is operated along the initial trajectory while the manipulator base portion moves together with the body 114. Therefore, while the traveling mechanism avoids the door so that the body 114 does not collide with the opening door, the manipulator can execute a work of holding the door handle and continuing to open the door.

However, since the collision avoidance calculation in the collision avoidance means 9 is executed with a period that is about several tens of times longer than the prioritized multi-target inverse kinematics calculation and the force control calculation executed in the order of milliseconds, a time delay occurs. This is because collision avoidance calculation is executed on a large amount of data acquired by sensors such as LiDAR and a three-dimensional camera, and it takes, when being long, several tens of milliseconds for these sensors to acquire distance data between the mobile work robot 111 and the surrounding environment.

Therefore, when the traveling mechanism is given the pose target value associated with collision avoidance during the object manipulation of the manipulator having the motion constraint, and the operation priority level of reaching the target increases, a slight overload may actually occur in the manipulator. In such a case, such an overload may be alleviated (even when the operation priority level of the traveling mechanism is as high as that of the manipulator, both operations of the traveling mechanism and the manipulator without causing overload on the manipulator is maintained and achieved) by the force control function. The function of the force control in the force control means 4 plays such an essential role in the interlocking between the manipulator and the traveling mechanism to which the present idea is directed.

For example, since a force control function such as compliance control, admittance control, or impedance control is provided, if only the arm tip pose for starting to move with the object and the arm tip pose in the final state of the operation are given in the operation of the object with movement constraint, such as various doors such as a sliding door and a hinged door, the trajectory from the former to the latter is determined in a driven manner according to the motion constraint.

Therefore, for example, even in the case of an arc-shaped target trajectory that opens a hinged door, only the target point in addition to the operation start point may be roughly given. This was demonstrated with an actual machine in FIG. 15. As illustrated in FIG. 15, the force control means 4 can also reduce the amount of teaching and the amount of preliminary calculation of the operation plan for the manipulator when a high operation priority level is set.

As a result, the amount of teaching of the pose of each actuation device can be significantly reduced in the entire autonomous mobile robot together with the traveling mechanism in which a low operation priority level is set for the manipulator to follow the operation of the manipulator without teaching or cooperatively operate to assist the operation of the manipulator.

The control device 1 of the autonomous mobile robot according to the present embodiment stores the movable angle range of the joint of the manipulator, and the joint angle range of the manipulator in which the manipulator interferes with the body of the autonomous mobile robot, the joint angle range of the manipulator in which the manipulator does not interfere with the body of the autonomous mobile robot, or one of the joint angle range of the manipulator in which the manipulator interferes with the body of the autonomous mobile robot and the joint angle range of the manipulator in which the manipulator does not interfere with the body of the autonomous mobile robot, determines whether a new joint angle of the manipulator that gives the next target pose falls within the interference region between the manipulator and the body of the autonomous mobile robot when the arm tip of the manipulator moves to the next target pose, and maintains the joint angle target command value in the calculation period without updating the joint angle target command value of the manipulator to the new joint angle of the manipulator when it is determined that the joint angle falls within the interference region.

The control device 1 of the autonomous mobile robot according to the present embodiment determines whether to enter the interference region between the manipulator and the body of the autonomous mobile robot based on the shape models of the manipulator and the body of the autonomous mobile robot in each control period in real time, determines whether the new joint angle of the manipulator that gives the next target pose falls within the interference region between the manipulator and the body of the autonomous mobile robot when the arm tip of the manipulator is moved to the next target pose, and maintains the joint angle target command value in the calculation period without updating the joint angle target command value of the manipulator to the new joint angle of the manipulator when it is determined to fall within the interference region.

This prevents interference between the manipulator and the body 114. The manipulator and traveling can be interlocked so as to prevent interference between the manipulator and the body 114 and to prevent interference with the body 114.

The difference between the arm tip target pose and the current arm tip pose with respect to the manipulator is reflected in the pose calculation of the traveling mechanism by the formulation characteristics of the prioritized multi-target inverse kinematics solution adopted by the present invention and the action thereof. Therefore, even if the movement of the manipulator is limited or stopped by the action of the joint angle limitation means, the traveling mechanism can move to travel in an interlocked manner to assist the arm tip to reach the target pose.

The control device 1 of the autonomous mobile robot according to the present embodiment has a format of executing, in parallel, programs of unit operations for the actuation devices of the autonomous mobile robot such as the manipulator, the traveling mechanism, and the hand, and the programs of the unit operations store at least the operation start pose, the passing pose, and the final target pose of the operation amount such as the joint angle and also store the operation priority level of reaching the final target pose.

For example, the same control device 1 controls the manipulator and traveling and walking of the body 114 in which the manipulator is installed, and also the operations of the manipulator and the traveling mechanism can be programmed in a unified and parallel manner in the same work program means. It is not necessary to switch teaching software and setting environment for each manipulator and traveling mechanism as is often seen in a mobile work robot in the related art. Since it is not necessary to teach the operation of the traveling mechanism, and the amount of teaching the operation of the manipulator can be significantly reduced by imparting the force control function, the work teaching amount and the work teaching time of the entire mobile work robot can be significantly reduced.

The control device 1 of the autonomous mobile robot according to the present embodiment has a function of determining whether the target pose of the manipulator arm tip is out of the operation range of the manipulator, adjusting the operation priority level of the traveling mechanism to the lower limit value when the target pose is out of the range, and suppressing the operation of the manipulator, thereby preventing the manipulator from traveling while being fully extended even though the manipulator does not operate the object.

For example, when moving to travel to the target pose where the arm tip of the manipulator does not reach and assist the arm tip to reach the target pose, it is dangerous to travel in a state where the manipulator is extended toward the target pose, even though the target pose is at a position where the arm tip does not reach.

In this case, the priority level determination means 6 determines whether the arm tip target pose is out of the operation range of the manipulator and sets the operation priority level of reaching the target pose of the traveling mechanism to 0 when the target pose is out of the operation range. Then, since the traveling mechanism completely travels to reduce the target pose error of the manipulator arm tip, the amount of movement of the manipulator to bring the arm tip close to the target pose relatively decreases.

If the traveling mechanism and the manipulator arm tip have the same operation speed, the manipulator does not need to move. Therefore, by traveling with the manipulator fully extended even though the object is not operated, it is possible to suppress a risk that the manipulator comes into contact with surrounding people and environments (ensure the safety in arrival assistance of the manipulator by traveling movement).

In the control device 1 of the autonomous mobile robot of the present embodiment, the program of the unit operation to which the operation priority level of the maximum limit value (1.0) is given disables adjustment of the operation priority level in the priority level determination means 6.

For example, if the operation priority level that is not the upper limit value of 1.0 is given to the manipulator that manipulates the object while being set to a high value close to the upper limit value of 1.0, for example, the priority level determination means 6 increases the operation priority level of the traveling mechanism according to the shortest distance output value of the collision avoidance means 9, and the priority level change is allowed so that the operation priority level of the manipulator is made lower than the operation priority level of the traveling mechanism. As a result, the manipulator operates out of the trajectory taught by the person, and in particular, the speed is likely to change from the value at each time point determined by the teaching.

For this reason, although the way of manipulating the object of the manipulator is not true to the teaching, the degree of freedom of behavior generation of the mobile work robot 111 increases, and a behavior that simultaneously establishes collision avoidance and object manipulation, for example, a behavior that continues to pull the handle of the door while avoiding collision with the opening door is more likely to be generated by the mobile work robot itself with less teaching of a person.

Meanwhile, when the operation priority level of the upper limit value of 1.0 is given to the manipulator that manipulates the object, the manipulator moves strictly along the trajectory taught by the person, and the change in speed with respect to the value at each time point determined by the teaching is also small. As a result, although the manner of operating the object is true to the teaching, even if the risk of collision of the traveling mechanism increases during that time, the traveling mechanism moves preferentially to establish the movement of the manipulator, and thus the collision avoidance manipulation amount becomes relatively small.

This makes it difficult to reduce the risk of collision between the mobile work robot 111 and the surroundings, and when collision between the body 114 and the surroundings occurs, the mobile work robot 111 stops due to an error from the interface unit of the bumper switch. Then, it is necessary to teach again to change the pose of the traveling mechanism at the start of the work behavior again.

As described above, it is possible to adjust whether to make the object manipulation true to the teaching or to reduce the fidelity to increase the degree of freedom of behavior generation depending on whether to set the upper limit value to the default value of the operation priority level of the actuation device according to the characteristic of the work behavior.

The above-described embodiment can be appropriately modified and implemented by changing a portion of the configuration or the function of the control device 1 of the autonomous mobile robot. Therefore, some modifications according to the above-described embodiment are described below. Hereinafter, points different from the above-described embodiment are mainly described, and detailed description of points common to the contents already described is omitted. The modifications described below may be implemented individually or may be implemented in appropriate combination.

### First Modification

When the traveling mechanism travels in an interlocked manner so as to assist the arm tip of the manipulator installed in the mobile work robot 111 to reach the target pose, the traveling direction can be arbitrarily changed at each time according to the direction of the target pose of the manipulator arm tip. Therefore, the traveling mechanism in the present embodiment is optimally an omnidirectional traveling mechanism capable of immediately moving in all directions.

Therefore, in the present embodiment, all the traveling mechanisms are assumed to be omnidirectional traveling mechanisms. The omnidirectional traveling mechanism includes any of a caster type, a mecanum wheel type, an omni wheel type, and a multi-leg walking type. The present idea is established for any omnidirectional traveling mechanism. The traveling and the traveling mechanism in the description may be replaced with walking and a walking mechanism.

However, the present embodiment does not set the omnidirectional traveling mechanism as a premise or condition of establishment. For example, there is actually an operation mode of a robot in which a traveling mechanism or a moving mechanism on which a manipulator is mounted moves only forward and backward, leftward and rightward, or upward and downward. It is apparent that the present embodiment is also effective for such an operation.

### Second Modification

In the present embodiment described above, a formulation example in which the structure of the autonomous mobile robot is a structure in which the right and left dual arm manipulators are installed in the traveling mechanism, and the prioritized multi-target inverse kinematics solution is extended to the structure is also described, but the present invention is not limited thereto. As long as the prioritized multi-target inverse kinematics solution can be extended in the same manner, for example, a rotary joint having a degree of freedom of turning, bending, or both corresponding to the human waist may be provided between the traveling mechanism and the manipulator. Alternatively, there may be a lifting mechanism such as a linear motion type.

### Third Modification

In the present embodiment, the types of operation priority levels determined by the priority determination unit are described as a total of three types of the traveling mechanism and the left and right manipulators in order to simplify the description. However, in more detail, the six control degrees of freedom of the traveling mechanism and the right and left manipulators may be individually set.

Although the embodiments of the present invention have been described above, the above-described embodiments have been presented as examples and are not intended to limit the scope of the present invention. This novel embodiment can be implemented in various other forms. Various omissions, substitutions, and changes can be made without departing from the gist of the invention. This embodiment is included in the scope and gist of the invention and is included in the invention described in the claims and the equivalent scope thereof.

### EXPLANATIONS OF LETTERS OR NUMERALS

1 CONTROL DEVICE
2 PRIORITIZED MULTI-TARGET INVERSE KINEMATICS CALCULATION MEANS
3 WORK PROGRAM MEANS
4 FORCE CONTROL MEANS
5 EACH AXIS ANGLE LIMITATION MEANS
6 PRIORITY LEVEL DETERMINATION MEANS
7 TARGET POSE TEACHING STORAGE MEANS
8 TRAJECTORY CALCULATION MEANS
9 COLLISION AVOIDANCE MEANS
111 MOBILE WORK ROBOT
112 RIGHT MANIPULATOR (MANIPULATOR)
113 LEFT MANIPULATOR (MANIPULATOR)
114 BODY

1. A control device of an autonomous mobile robot that includes one or more manipulators that has a distal end to which a hand for manipulating an object is attached to move it, and a traveling mechanism that is immediately movable in all directions, the control device comprising:
a prioritized multi-target inverse kinematics calculation circuit that obtains a solution while assuming that there is a virtual spring between a current pose and a target pose, and each joint receives virtual torque from the virtual spring; and
a priority level determination means circuit that individually adjusts operation priority level coefficients that are individually assigned to actuation devices constituting the autonomous mobile robot, by which a spring coefficient of the virtual spring is multiplied, and that correspond to operation priority levels of the actuation devices.

2. The control device of the autonomous mobile robot according to claim 1, comprising
a collision avoidance circuit for avoiding a collision based on a distance measurement value to a periphery of the autonomous mobile robot,
wherein the priority level determination circuit corrects a target position of the traveling mechanism by adding a target position correction amount given as a first output by the collision avoidance circuit, and
varies values of the operation priority levels of the traveling mechanism and the manipulator by which the spring coefficient is multiplied according to a collision risk given as a second output by the collision avoidance circuit.

3. The control device of the autonomous mobile robot according to claim 1, comprising:
a first axis angle limitation circuit that stores a movable angle range of a joint of the manipulator, and any of a first joint angle range of the manipulator in which the manipulator interferes with a body of the autonomous mobile robot, a second joint angle range of the manipulator in which the manipulator does not interfere with the body, and a third joint angle range including the first joint angle range and the second joint angle range,
wherein, when an arm tip of the manipulator is moved to a next target pose, the prioritized multi-target inverse kinematics calculation circuit determines, with the first axis angle limitation circuit, whether a new joint angle of the manipulator that gives the next target pose calculated by an inverse kinematics solution falls within an interference region between the manipulator and the body of the robot, and maintains a joint angle target command value in a previous calculation period without updating a joint angle target command value of the manipulator to the new joint angle of the manipulator when determining that it falls within the interference region.

4. The control device of the autonomous mobile robot according to claim 1, comprising
a second axis angle limitation circuit that determines whether the manipulator and the body of the autonomous mobile robot enters an interference region therebetween based on shape models including the manipulator and the body to check interference in real time in each control period,
wherein, when an arm tip of the manipulator is moved to a next target pose, the prioritized multi-target inverse kinematics calculation circuit determines, with the second axis angle limitation circuit, whether a new joint angle of the manipulator that gives the next target pose calculated by an inverse kinematics solution falls within the interference region between the manipulator and the body of the robot, and maintains a joint angle target command value in a previous calculation period without updating a joint angle target command value of the manipulator to the new joint angle of the manipulator when it is determined that it falls within the interference region.

5. The control device of the autonomous mobile robot according to claim 1, comprising
a force control circuit based on any control law among admittance control, compliance control, and impedance control in a control unit controller of the manipulator.

6. The control device of the autonomous mobile robot according to claim 1,
wherein the priority level determination circuit determines whether a target pose of an arm tip of the manipulator is out of an operation range of the manipulator, and adjusts an operation priority level of the traveling mechanism to a lower limit value to suppress an operation of the manipulator, when the target pose is out of the range.

7. The control device of the autonomous mobile robot according to claim 1, wherein
a control program stored in a work program circuit constituting the control device of the autonomous mobile robot is in a form in which programs of unit operations of the actuation devices are executed in parallel, and
the program of each unit operation stores at least an operation start pose, a passing pose, and a final target pose of an operation amount of a joint angle and stores an operation priority level of reaching the final target pose.

8. The control device of the autonomous mobile robot according to claim 7,
wherein a program of a unit operation to which an operation priority level of a maximum limit value is assigned disables adjustment of the operation priority level in the priority level determination circuit.

9. A control method of an autonomous mobile robot that includes one or more manipulators that has a distal end to which a hand for manipulating an object is attached to move it, and a traveling mechanism that is immediately movable in all directions, the control method comprising:
obtaining a solution while assuming that there is a virtual spring between a current pose and a target pose, and each joint receives virtual torque from the virtual spring; and
individually adjusting operation priority level coefficients that are individually assigned to actuation devices constituting the autonomous mobile robot, by which a spring coefficient of the virtual spring is multiplied, and that correspond to operation priority levels of the actuation devices.
